(19) United States
(12) Patent Application Publication
(10) Pub. No.: US 2007/0239232 A1
(43) Pub. Date: Oct. 11, 2007

(54) Light guide based light therapy device

(75) Inventors: Andrew F. Kurtz, Macedon, NY (US); James E. Roddy, Rochester, NY (US); Fred D. Kelley, Webster, NY (US); James R. Kircher, Mendon, NY (US); Mark E. Bridges, Spencerport, NY (US); Mark D. Bedzyk, Pittsford, NY (US)

Correspondence Address: Eastman Kodak Company, 343 State Street, Rochester, NY, 14650-2201, US

(73) Assignee: Eastman Kodak Company

(21) Appl. No.: 11/390,837

(22) Filed: Mar. 28, 2006

(51) Int. Cl. A61H 33/00; A61H 21/00

(52) U.S. Cl. 607/87; 607/88

(57) ABSTRACT

A light therapy device (40) for delivering light energy to treat medical conditions in tissues (200) includes a light source (300) with one or more light emitters, which provides input light (305). A light coupling means comprised of one or more optical fibers (310) for coupling the input light into a bandage portion (100) comprising a flexible optical substrate (50). A light extraction means (30) directs a portion of the input light out of the bandage and towards one or more localized areas of the tissues. A semi-permeable transparent membrane (400), attached directly or indirectly to the substrate, controls a flow of moisture and moisture vapor to and from the tissues. A controller (16) means controls a light dosage emitted from the light therapy device.

### CROSS REFERENCE TO RELATED APPLICATIONS

Reference is made to commonly-assigned copending U.S. patent application Ser. No. 11/087,300 filed Mar. 23, 2005, entitled LIGHT GUIDE BANDAGE, by Olson et al., the disclosure of which is incorporated herein.

### FIELD OF THE INVENTION

The invention relates generally to a light therapy device and in particular, to a light therapy device for use in close proximity, or in contact with, the skin or a patient.

### BACKGROUND OF THE INVENTION

The term “phototherapy” relates to the therapeutic use of light, and the term “illuminator” or “light therapy device” or “phototherapy device” refers to a device that is generally intended to be used externally to administer light to the skin of a patient for therapeutic purposes.

External light therapy has been shown to be effective in treating various medical conditions, for example, seasonal affective disorder, psoriasis, acne, and hyperbilirubinemia common in newborn infants. Light therapy has also been employed for the treatment of wounds, burns, and other skin surface (or near skin surface) ailments. As one well-known example, light therapy can be used to modify biological rhythms in humans, such as circadian (daily) cycles that affect a variety of physiologic, cognitive, and behavioral functions. Light therapy has also been used for other biological treatments that are less recognized. For example, in the late 1800's, Dr. Niels Finsen found that exposure to ultraviolet radiation aggravated smallpox lesions. Thus, he illuminated his patients with light with the UV filtered out. Dr. Finsen further discovered that exposure with the residual red light sped healing in recovering smallpox victims. Finsen also determined that ultraviolet radiation could be used to heal tuberculosis lesions. As a result, in 1903, Dr. Finsen was awarded a Nobel Prize for his use of red light therapy to successfully treat smallpox and tuberculosis.

In the 1960's and 1970's researchers in Eastern Europe undertook the initial studies that launched modern light therapy. One such pioneer was Endre Mester (Semmelweiss Hospital; Budapest, Hungary), who in 1966, published the first scientific report on the stimulatory effects of non-thermal ruby laser light (694 nm) exposure on the skin of rats. Professor Mester found that a specific range of exposure conditions stimulated cell growth and wound healing, while lesser doses were ineffective and larger doses were inhibitory. In the late 1960's, Professor Mester reported the use of laser light to treat non-healing wounds and ulcers in diabetic patients. Mester's 70% success rate in treating these wounds lead to the development of the science of what he called “laser biostimulation.”

Photodynamic therapy (PDT) is one specific well-known example of light therapy, in which cancerous conditions are treated by a combination of a chemical photo-sensitizer and light. Typically in this instance, several days before the light treatment, a patient is given the chemical sensitizer, which generally accumulates in the cancerous cells. Once the sensitizer concentrations in the adjacent non-cancerous cells falls below certain threshold levels, the tumor can be treated by light exposure to destroy the cancer while leaving the non-cancerous cells intact.

As compared to PDT, light therapy, as exemplified by Professor Mester's pioneering work, involves a therapeutic light treatment that provides a direct benefit without the use of enabling external photo-chemicals. Presently, there are over 30 companies world wide that are offering light therapy devices for a variety of treatment applications. These devices vary considerably, with a range of wavelengths, power levels, modulation frequencies, and design features being available. In many instances, the exposure device is a handheld probe, comprising multitude light emitters; that can be directed at the patient during treatment. The light emitters, which typically are laser diodes, light emitting diodes (LEDs), or combinations thereof, usually provide light in the red-IR (˜600-1200 nm) spectrum, because the tissue penetration is best at those wavelengths. In general, both laser light and incoherent (LED) light seem to provide therapeutic benefit, although some have suggested that lasers may be more efficacious. Light therapy is recognized by a variety of terms, including low-level-laser therapy (LLLT), low-energy-photon therapy (LEPT), and low-intensity-light therapy (LILT). Despite the emphasis on “low” in the naming, in actuality, many of the products marketed today output relatively high power levels, of up to 1-2 optical watts. Companies that presently offer light therapy devices include Thor Laser (United Kingdom), Omega Laser Systems (United Kingdom), MedX Health (Canada), Quantum Devices (United States) and Lumen Photon Therapy (United States).

Many different examples of light therapy and PDT devices are known in the patent art. Early examples include U.S. Pat. No. 4,316,467 (Muckerheide) and U.S. Pat. No. 4,672,969 (Dew). The most common device design, which comprises a hand held probe, comprising at least one light emitter, but typically dozens (or even 100) emitters, that is attached to a separate drive controller, is described in numerous patents, including U.S. Pat. No. 4,930,504 (Diamantapolous et al.); U.S. Pat. No. 5,259,380 (Mendes et al.); U.S. Pat. No. 5,464,436 (Smith); U.S. Pat. No. 5,634,711 (Kennedy et al.); U.S. Pat. No. 5,660,461 (Ignatius et al.); U.S. Pat. No. 5,766,233 (Thiberg); and U.S. Pat. No. 6,238,424 (Thiberg).

One shortcoming of the probe type laser therapy device is that it requires the clinician, or perhaps the patient, to actively apply the laser light to the tissue. Typically, the clinician holds the light therapy probe, aims the light at the tissue, and operates the device according to a treatment protocol. As a result, the laser therapy devices are often designed to emit high light levels, in order to reduce the time a clinician spends treating an individual patient to a few minutes or less, whether the application conditions are optimal or not. Additionally, in many such cases, the patient is required to travel to the clinician's facility to receive the treatment. Because of this inconvenience, patients are typically treated only 1-3 times per week, even if more frequent treatments would be more efficacious.

Certainly, these shortcomings with the handheld probes have been previously identified. For example, Laser Force Therapy (Elizabeth, Colo.) offers a disk-shaped probe (the “Super Nova”) that can be strapped onto the patient. While this is a potential improvement, the device does not conform to the shape of the tissue being treated. As an alternate approach, a variety of self-emissive light bandages have been suggested, in which a conformal pad having a light emitting inner surface is strapped directly on the patient. Since the patient can wear the device, perhaps under their clothes for a prolonged period of time, the convenience limitations of the handheld probe may be overcome.

As a first example, U.S. Pat. No. 6,569,189 (Augustine et al.) provides a heat therapy bandage that uses IR blackbody radiation generated from electrical resistance in circuit trace within the bandage. In this case, since the emitted light is broadband IR (nominally 3-30 microns), this bandage does not enable the use of specific illumination optical wavelengths that have been suggested to be optimal for treating various conditions. In particular, the wavelengths provided by this device may not advantageously activate the known photo-acceptor molecules in cells. Moreover, this device does not offer a means to vary the light spectrum in any useful way.

Alternately, light therapy devices have been described that use discrete light emitters fabricated into a dressing or bandage. As a first example, U.S. Pat. No. 6,569,189 (Augustine et al.) provides a heat therapy bandage that uses IR blackbody radiation generated from electrical resistance in circuit trace within the bandage. In this case, since the emitted light is broadband IR (nominally 3-30 microns), this bandage does not enable the use of specific illumination optical wavelengths that have been suggested to be optimal for treating various conditions. In particular, the wavelengths provided by this device may not advantageously activate the known photo-acceptor molecules in cells. Moreover, this device does not offer a means to vary the light spectrum in any useful way, nor is it optimized for wound treatment.

As a second example, Omnilight (Albuquerque, N. Mex.) offers the Versalight pads, which combine a controller (such as the VL3000) with a pad, where the pads comprise a multitude of discrete LEDs imbedded in a neoprene-covered foam. Bioscan Inc. (Albuquerque, N. Mex.) offers a similar suite of products for veterinary applications. In both cases, the products typically comprise a mix of IR and red LED emitters, arranged in a pattern across the pad. These devices are described in U.S. Pat. No. 4,646,743 (Parris), which teaches conformal pad light therapy devices in which an array of diodes is imbedded in pliable foam. These devices have greater flexibility than the prior one, but are again not optimized for wound treatment.

Several other device designs beyond that of U.S. Pat. No. 4,646,743 are known in the prior art, including:
U.S. Pat. No. 5,358,503 (Bertwell et al.), which provides a conformal pad utilizing tightly packed LEDs and adjacent resistors, which is placed in contact with the tissue, so as to provide both light and thermal treatments.
U.S. Pat. No. 5,913,883 (Alexander et al.), which provides a conformal therapeutic facial mask comprising a plurality of LEDs held off of the tissue by spacer pads.
U.S. Pat. No. 6,096,066 (Chen) provides a conformal light therapy patch having addressable LEDs interconnected by control circuitry and having perspiration slits.
U.S. Pat. No. 6,443,978 (Zharov) describes a conformal light source array device that has spacer layers to hold the emitters off the tissue, bio-sensors, and magnetic stimulators.
U.S. Pat. No. 5,616,140 (Prescott) provides a conformal light therapy bandage comprising light emitters and flexible drive circuitry fabricated within a multi-layer pad. This patent comes closest to describing an imbedded emitter light therapy bandage, but the design is not optimized for large area conformability, operational temperature, or for wound care.

As an alternate approach, there are a variety of technologies being developed that involve self-emissive devices, rather than employing discrete emitters imbedded in a substrate. For example, devices have been described that use organic light emitting diodes (OLEDs), polymer light emitting diodes (P-LEDs), and thin film flexible electroluminescent sources (TFELs). As an example, U.S. Pat. No. 6,096,066 (Chen et al.) teaches a flexible LED array on a thin polymer substrate, with addressable control circuitry, slits for perspiration, and the use of LEDs, which could be replaced with OLEDs. Similarly, U.S. Pat. No. 6,866,678 (Shenderova) discloses a thin film electroluminescent (TFEL) phototherapy device based on high field electroluminscence (HFEL) or OLED technologies. Certainly, light therapy bandages based on these technologies have several potential advantages, including volume production, readily customizable temporal and spatial control from the addressing circuitry, and a very thin from factor, which could help conformability. However, even in the display markets (laptop computers, television, etc.), which is the primary target market, OLED technologies are not yet sufficiently mature to support volume production. Also, while self emissive light bandages will not be encumbered by lifetime issues and the resolution requirements imposed on the display market, such bandage type devices will have their own issues (minimizing toxicity, handling moisture, and providing sufficient output power or IR output light) that will likely effect the appearance of such devices in health markets.

While these various patents provide designs for conformal light therapy pads, these devices are hampered by an awkward construction, which typically involves mounting some number of rigid discrete diodes (lasers or LEDs) within a conformal pad, accompanied by the required drive circuitry and thermal management means; As a result, these devices are encumbered by some manufacturing difficulties that affect unit cost, and which may limit the potential that these devices could become ubiquitous, if not disposable.

As an alternate approach, there are a variety of technologies being developed for self emissive devices, such as organic light emitting diodes (OLEDs), polymer light emitting diodes (P-LEDs), and thin film flexible electroluminescent sources (TFELs), which could readily enable volume production. As an example, U.S. Pat. No. 6,096,066 (Chen et al.) teaches a flexible LED array on a thin polymer substrate, with addressable control circuitry, slits for perspiration, and the use of LEDs, which could be replaced with OLEDs. Similarly, U.S. Pat. No. 6,866,678 (Shenderova) discloses a thin film electroluminescent (TFEL) phototherapy device based on high field electroluminescence (HFEL) or OLED technologies. Certainly, light therapy bandages based on these technologies have several potential advantages, including volume production and customizable temporal and spatial control from the addressing circuitry. However, even in the target display markets (laptop computers, television, etc.). OLED technologies are not yet sufficiently mature to support volume production. Also, while self emissive light bandages will not be encumbered by lifetime issues and the resolution requirements imposed on the display market, such bandage type devices will have their own issues (minimizing toxicity, providing sufficient output power or IR output light) that will likely effect the appearance of such devices in health markets.

Therapeutic light pads have also been developed using woven bundles of optical fibers. Such devices are typically marketed for use in treating jaundice in infants. One example is the Biliblanket Plus, offered by Ohmeda Medical (Baltimore, Md.), which uses a high intensity halogen lamp, mounted in a controller and light coupled-into a fiber-bundle. The fiber bundle, nominally comprising 2400 individual optical fibers, is configured into a woven pad, in which the bends in the optical fibers cause local breakdown in total internal reflection, so that light is coupled out of the fiber over the full surface area of the pad. Another company, Respironics (Murrysville, Pa.), offers a similar system, the Wallaby Phototherapy System, for neonatal care of jaundice. The basic concept for a woven fiber-optic illuminator is described in U.S. Pat. No. 4,234,907 (Daniel).

This type of medical light therapy pad, using an illuminator comprising a woven mat of optical fibers, is described in prior art patents U.S. Pat. No. 5,339,223 (Kremenchugsky et al.) and U.S. Pat. No. 5,400,425 (Nicholas et al.), both assigned to Ohmeda Inc. For example,a prior art light therapy device 40 of U.S. Pat. No. 5,400,425, shown in FIG. 1, comprises a woven fiber-optic pad 10 connected by a fiber-optic cable 12 to a drive unit 14 that houses a source of light. The fiber-optic cable 12 has a protective coating of a plastic material such as vinyl and contains a plurality of individual optical fibers, not shown in FIG. 1, which transmit the light from the drive unit 14 to the woven fiber-optic pad 10 for emission toward the infant. A connector 16, affixed to an end of fiber-optic cable 12, positions the cable to receive light energy from a light source (internal to the drive unit 14 and not shown). The light source is typically a quartz halogen lamp, although xenon lamps, tungsten halogen lamps, LEDs, and other light sources can be used. Also within the drive unit 14 are the various electrical components and optical components, the latter including optical filters to obtain the desired wavelength of the light radiation delivered to the fiber-optic cable 12 in the range of about 400 to 550 nanometers. Other filters may filter out infrared and UV radiation spectrums from the light radiation delivered. The housing 14 is also shown equipped with a controller 20 and a display 22 mounted on the front panel 24, which may facilitate intensity and frequency modulation of the light. In combination with the drive unit 14, fiber-optic pad 10 comprises a plurality of optical fibers woven so as to emit light energy for phototherapy. U.S. Pat. No. 6,494,899 (Griffin et al.), assigned to Respironics Inc., provides an improved device in which the lamp source can be automatically changed after a lamp failure.

U.S. Pat. No. 4,907,132, (Parker) provides an improved woven fiber-optic light therapy device where the pad is designed for improved light efficiency and controlled output. Accordingly, the uniformity of illumination of a pad may be varied by varying the shape of the optical fiber disruptions or bends and/or the spacing between such disruptions or bends as by varying the pattern and tightness of the weave or by varying the proportion of optical fibers to other material in the weave. U.S. Pat. No. 4,907,132 also provides that the fiber-optic pad may have a transparent coating laminated applied to the outer surfaces of the disruptions or bends on one or both sides of each optical fiber layer. The coating is intended to cause changes in the attenuation of light being emitted from the pad. The coating increases the overall optical efficiency of the pad by causing attenuation changes only where the light normally escapes from the disruptions or bends of the woven optical fiber panel. While control of the pattern and tightness weave certainly will effect light emission over the pad, such customization likely occurs at the factory, rather than at a clinic or even in the home. The other approach, with the transparent overcoat layers, may lend itself to customization at the treatment facility. However, while the over coat seems to offer effective control of the light output, fiber-optic light emission at the bends is largely controlled by the radius of the bends and the core and cladding refractive indices, and applying a transparent coating onto the cladding may only have a secondary effect on the light emission characteristics.

These prior approaches, based on woven fiber optic mats, do not provide a means for spatially localizing the light therapy within a treatment area, as can be desirable for a wound care bandage or dressing. As another approach, the optical design concepts used in display backlighting could be applied to light therapy. In such systems, light is typically pumped into an edge of a light guide, where upon it is diffused and directed out of an exit face to a display panel, such as an LCD. Although display backlights are optimized for different characteristics (uniformity, angular range, polarization alignment and purity, RGB spectra, lumen output, etc.). than potentially needed for a light therapy device. (localized light application, irradiance, Red and IR spectra) the backlighting technology concepts could be extensible.

U.S. Patent Application Publication No. 2003/0202338 (Parker), as shown in FIG. 2, describes a light guide therapy pad 100 with one or more light sources 300 (LEDs) imbedded at an edge of a transparent light guide 50. The emitted light expands and diffuses around within a transition area 32 and then encounters various light extraction features 30 (such as deformities or prismatic surfaces) that cause therapeutic light 62 to be scattered out towards the tissue. Parker '338 does recognize the need for a light guide light therapy illuminator to be curved or conformal so as to follow the contours of a patient's body. However, Parker '338 minimally describes design attributes that could enhance conformability. As with the woven fiber optics mats, the Parker '338 publication also does not describe a need or a means for providing localized light application, and has light extraction occurring over the entire surface (or nearly so) of the entire exit surface 60. Furthermore, Parker '338 also does not discuss how a light guide illuminator can be designed to function as a primary or secondary wound care dressing.

Another relevant document is U.S. Pat. No. 6,743,249 (Alden), which primarily describes a-light therapy treatment device comprising a multitude of imbedded interconnected light emitters mounted in a liner, with a surrounding shell, and a heat dissipating layer. However, Alden '249 also describes (see FIGS. 3a-3c) a light therapy pad 100 in which a multitude of optical fibers 310 are imbedded in a light guiding substrate. Alden '249 describes that therapeutic light is emitted from the optical fiber ends 315 into a liner material 35, from whence it reflects and scatters to reach an exit surface 60. The liner, which is formed within a shell 37, is described as nominally comprising a transparent tacky silicone gel material. Alden '249 does not describe how to preferentially direct uniform illumination light out of the liner and towards the tissue. Alden '249 also does not describe a need or a means for providing localized light application. Likewise, Alden '249 does not discuss how a light guide illuminator can be designed to function as a wound care dressing having the needed occlusivity and conformability.

Although these various patents include many interesting elements, none of them have really presented a design for a light guide therapy bandage or dressing that is sufficiently conformal to be applied in close contact to the complex three-dimensional shapes present on the human body, such as the sole of the foot, or the lower back. Additionally, there are opportunities to improve the efficiency and localization of the light delivery, while addressing the laser safety issues that can arise. Finally, there are opportunities to improve the design of this type of device relative to the potential use as a primary or secondary wound care dressing.

### SUMMARY OF THE INVENTION

Briefly, according to one aspect of the present invention a light therapy device for delivering light energy to treat medical conditions in tissues comprises a light source with one or more light emitters, which provides input light. A light coupling means comprised of one or more optical fibers for coupling the input light into a bandage portion comprising a flexible optical substrate. A light extraction means directs a portion of the input light out of the bandage and towards one or more localized areas of the tissues. A semi-permeable transparent membrane, attached directly or indirectly to the substrate, controls a flow of moisture and moisture vapor to and from the tissues. A controller means controls a light dosage emitted from the light therapy device.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIG. 1 shows a perspective view of a prior art light therapy device comprising a fiber-optic mat type illuminator and a drive unit.

FIG. 2 shows a perspective view of a prior art light guide based light therapy device.

FIGS. 3a-3c show a side view and two top views of a prior art light guide based light therapy device utilizing fiber optics.

FIG. 4 is a perspective view, partly in phantom, of a light therapy device concept of the present invention.

FIGS. 5a and 5b show side views of the general concept for a light therapy bandage according to the present invention.

FIG. 6 shows a picture of human tissue having a chronic wound.

FIGS. 7a-7c show top views of the light guide substrate of the light therapy bandage of the present invention, with different configurations of light extraction.

FIGS. 8a-8c show cross sectional representative side views of wounds in combination with a light therapy wound dressing device of the present invention.

FIGS. 9a and 9b show detailed cross-sectional side views of the light therapy device of the present invention.

FIGS. 10a-10c show detailed views of different concepts for an intermediate assembly within the light therapy device of the present invention.

FIGS. 11a-11e show detailed cross sectional side views of several designs for light extraction from a light therapy bandage of the present invention.

FIGS. 12a-12g show cross sectional top views of several designs for a light therapy bandage of the present invention.

FIGS. 13a-13d show various views of illustrations related to a light therapy bandage of the present invention that utilizes imbedded optical fibers.

FIGS. 14a and 14b, show a side cross-sectional view and top cross sectional view respectively of a light therapy bandage of the present invention that utilizes a substrate comprising a flexible transparent optical gel or foam.

FIG. 15 depicts an embodiment of the light guide bandage with laser safety interlock features.

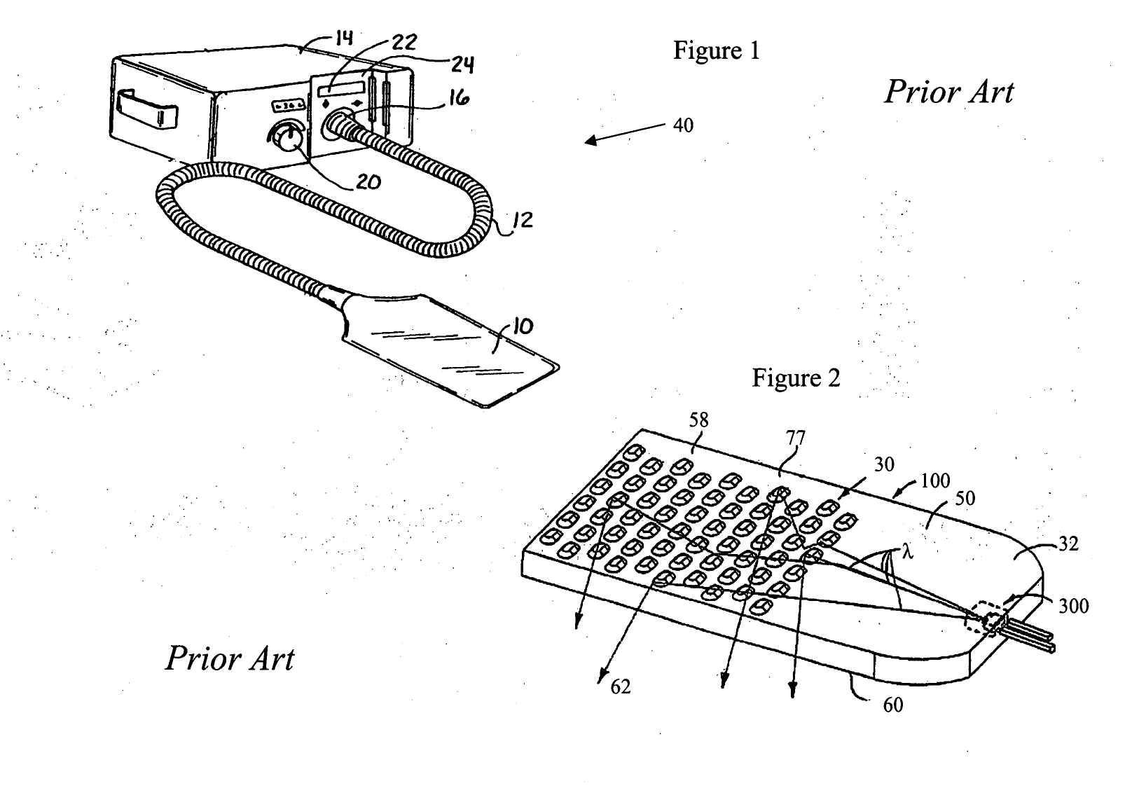

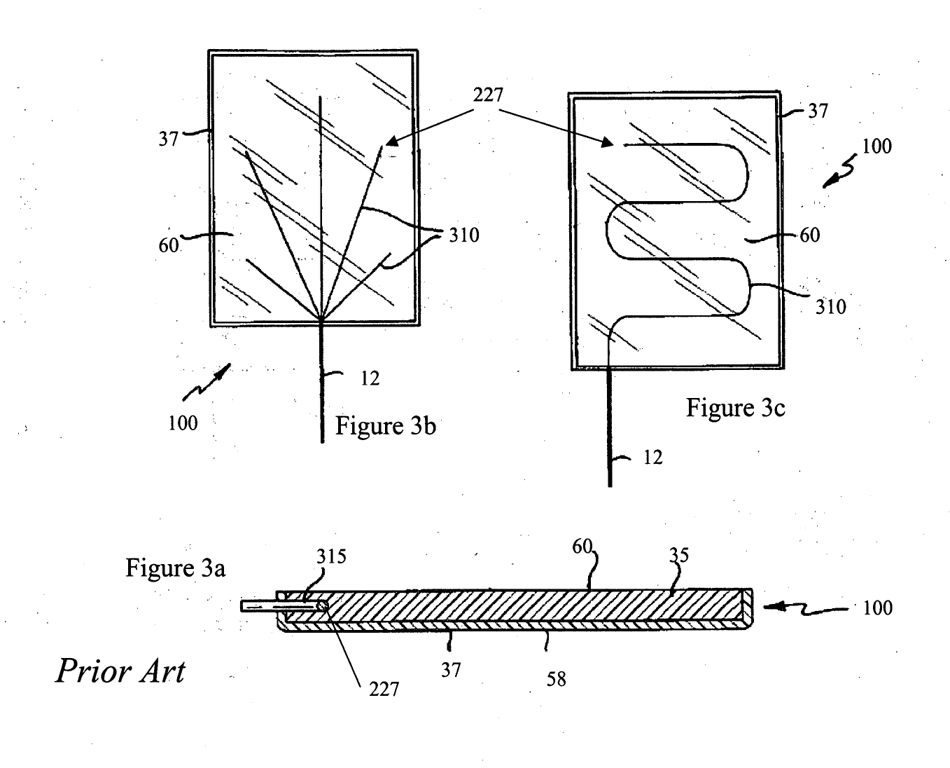

### DETAILED DESCRIPTION OF THE INVENTION

The following is a detailed description of the preferred embodiments of the invention, reference being made to the drawings in which the same reference numerals identify the same elements of structure in each of the several figures.

The present invention provides a flexible light therapy device having a plurality of applications, including but not limited to, the treatment of seasonal affective disorder, psoriasis, acne, diabetic skin ulcers, pressure ulcers, PDT, and hyperbilirubinemia common in newborn infants. The present invention delivers light energy by means of a flexible member that can be placed in contact with the skin of a patient. The present invention comprises a light guide therapy bandage or dressing, in which light is input coupled into the light guide, nominally by optical fibers. Light is directed out of the device by a light extraction layer, which can be a thin film layer or surface treatment that is applied to the light guide itself or to the imbedded optical fibers. The light extraction features are intended to enable localized application of therapeutic light. The device is nominally designed to be readily worn by the patient for a prolonged time period, and is potentially disposable thereafter.

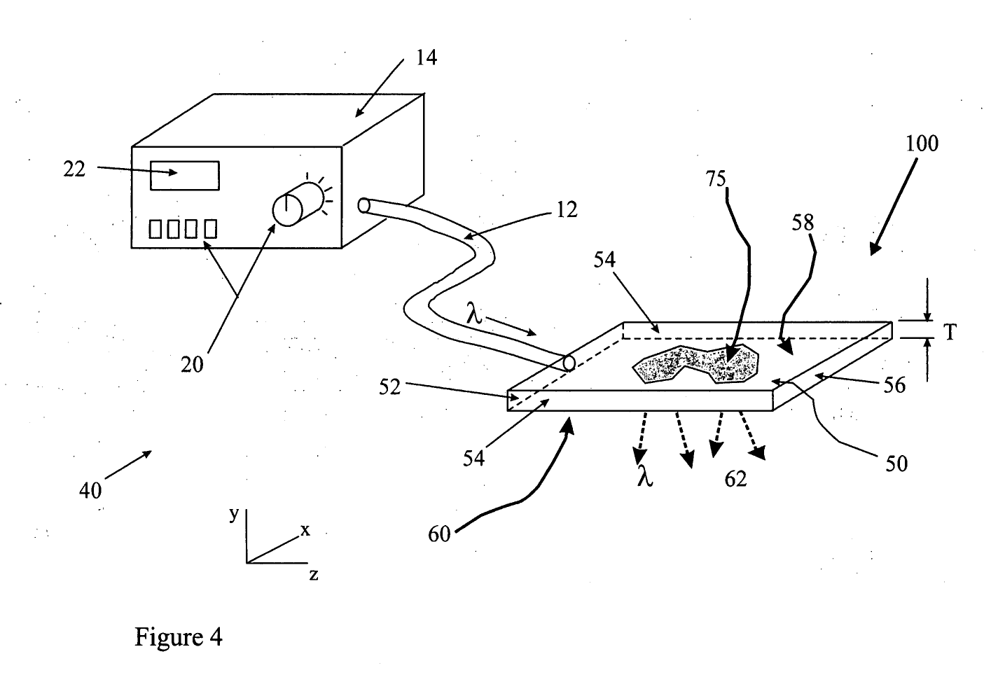

The basic concept for the general device, as was described in the commonly assigned U.S. patent application Ser. No. 11/087,300 by Olson et al., is shown in FIG. 4. Light therapy device 40 comprises a drive unit 14 with an internal light source (not shown), a fiber-optic cable 12 to couple light from the light source into the light therapy pad; The drive unit 14 can be equipped with a display 22 and a controller 20, which facilitates setting of treatment parameters such as light intensity, frequency wavelength, modulation, and repeat treatment timing. While fiber-optic cable 12 is nominally identified as containing a fiber-optic bundle, other flexible light piping means can be used, such as liquid light pipe or solid dielectric-light pipe. The bandage 100 is preferably a low cost consumable, while controller 20 could be offered via an equipment rental.

The light guide therapy bandage 100 depicted in FIG. 4 is nominally a transparent optical sheet, wherein light is input coupled at input surface 52. Light is then trapped within the light guide substrate by reflections off of outer surface 58, inner surface 60, side surfaces 52 and 54, and end surface 56. A portion of the light trapped within the light guide substrate 50 encounters light extraction layer 75, which re-directs the light, so that it is coupled out of the light guide substrate 50 as therapeutic light 62. This light is intended to be nominally normally incident to the tissue, with'same reasonable angular spread (such as 30 degrees half angle). Light guide substrate 50 is nominally a non-woven sheet material, such as a flexible transparent elastomeric polymer polyurethane. End surface 56 will likely utilize a reflective layer as mirror layer 82. This reflective layer could be a dielectric (TiO₂ or SiO₂ for example) or a metal (aluminum, for example) layer to reflect the incident light back into the light guide substrate 50. A commercial reflectance film, such as 3M Vikuiti enhanced specular reflection film (ESR). can also be used, with an intermediate adhesive layer used to attach the film to light guide substrate 50. Light guide therapy pad 100 is nominally a wave-guide, with a thickness T that supports multi-mode light guiding along its length and across its width.

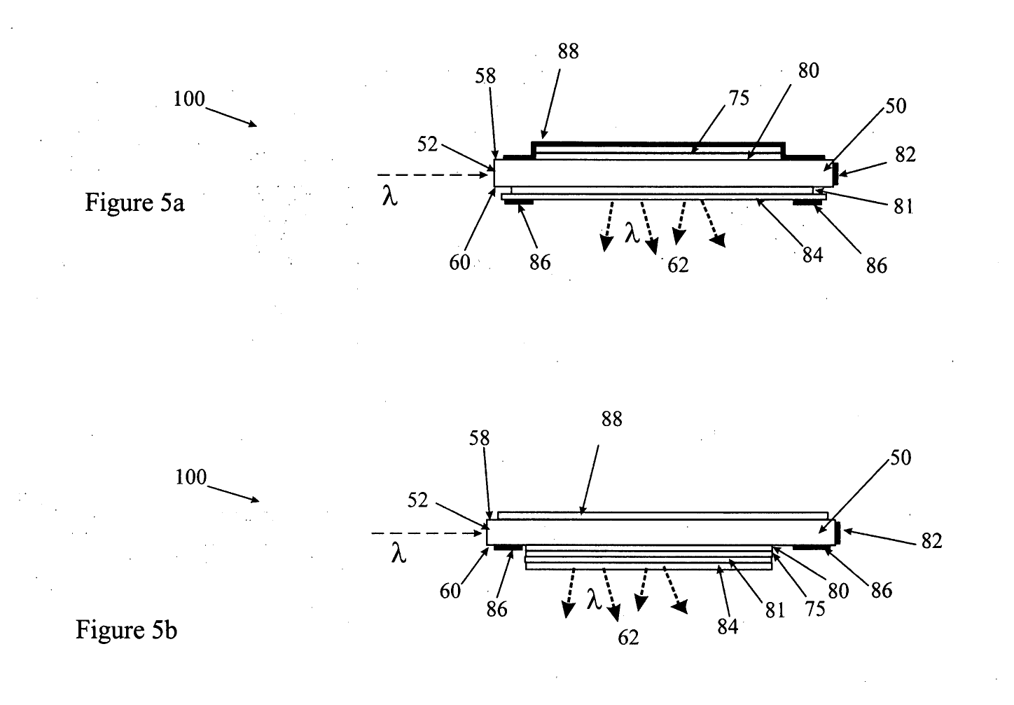

FIGS. 5a and 5b depict cross sectional views of two basic constructions for the light guide therapy bandage 100. In the case of FIG. 5a, light guide therapy bandage 100 comprises light guide substrate 50, with a light extraction layer 75 mounted on outer surface 58. Light extraction layer 75 is nominally a reflective optical diffuser, such as the white reflective diffusers commonly used in the manufacture of laptop computer displays, such as the LTO series reflective diffuser from Tsujiden Co. Ltd. (Japan). In this case, light that incident into the light guide substrate 50 reflects internally until it encounters the diffusing light extraction layer 75. Most of this incident light then diffusely reflects from the light extraction layer 75, back towards the light guide substrate 50, through the thickness T of the light guide substrate 50, and exits out the inner surface 60 as therapeutic light 62. Of course, some of the diffusely reflected light will be reflected such that it remains trapped within the light guide substrate 50. After multiple reflections, a portion of that light will again encounter the light extraction layer 75, where it will again be diffusely reflected, and may yet contribute to the therapeutic light 62 emerging from the device. FIG. 5a also depicts light guide therapy bandage 100 as constructed with an optional optical coupling layer 80 between light extraction layer 75 and substrate 50. This layer could have both refractive index matching properties and adhesive properties to enhance the efficiency and uniformity of the optical diffusion.

Other properties of a light guide therapy bandage 100 are depicted in FIG. 5a. For example, end surface 56 can be coated with a mirror layer 82 to prevent the light from spilling out the ends of the light guide substrate 50. Side surfaces 54 (shown in FIG. 4) could also be provided with a mirror layer (such as 3M ESR film) rather than relying on total internal reflection to provide the light trapping. Surfaces 54, 58, and 60 could also be coated with scattered matte beads to provide miniature standoffs; so that other applied layers and materials could be kept from defeating the total internal reflection of the light guide outside the treatment area. Input surface 52 could likewise have a mirror coating, aside from any clear apertures that are provided for the input light to enter the light guide substrate 50. A cover 88 can be provided on the outer surface 58. Cover 88 could be a coating or a sleeve, made of gauze or some other material. It could serve several functions, including to protect the light guide therapy bandage 100 from damage and contamination (from pathogens; and optically (to prevent degradation of the reflecting and diffusing properties of the bandage surfaces), or to fasten the therapy bandage to other bandage elements (such as straps), etc. Cover 88 could also provide a non-stick surface, so the light guide therapy pad 100 does not catch on clothing the patient may wear over the pad.

Light guide substrate 50 may also have layers and coatings on the inner surface 60. For example, a tissue interface layer 84 can be provided, which could have antibiotic properties or bio-sensing capabilities. For example, tissue interface layer 84 could have topical agents that fight infection (including anti-biotic silver), encourage epithelialization or other tissue healing activities, or amplify the effects of light therapy. In the case of bio-sensing, the bio-sensor features might detect a bio-physical or biochemical condition of the treatment area, which can then be used as input to guide further treatments. For example, the biosensors might detect the presence or absence of certain pathogens or enzymes associated with infections, or other enzymes and proteins associated with healing. Light guide bandage 100 could also be equipped with a sensing means that changes color relative to time to indicate the time (or amount of exposure) and thereby indicates an end to a given therapy session. For example, biosensors could be used to look for biochemical indications of the effective dosage applied. Alternately, optical sensors could detect the backscattered light as measure of the optical dosage delivered. The end of session control could then be manual or automatic. Light guide substrate 50 may also have adhesive layers 86 on the inner surface 60, which might help to attach the light guide therapy bandage 100 directly onto the tissue, or to other bandage elements. Alternately, adhesive layers 86 could represent other types of attachment means, such as Velcro, which could be used to fasten the light guide therapy bandage 100 to other bandage elements.

An alternate cross-sectional construction of light guide therapy bandage 100 is shown in FIG. 5b. In this case, a transmissive light extraction layer 75 is provided on the inner surface 60 of light guide substrate 50. Light extraction layer 75 could have a micro-structured optical surface, with micro-prisms, micro-lenses, or other features, which will cause incident light (from internal to light guide substrate 50) to refract, diffract, and/or scatter out of the light guide substrate 50 and emerge as therapeutic light 62. An exemplary light extraction layer could be a brightness enhancement film (BEF) from 3M. Potentially, extraction layer 75 could be formed with micro-structured light extraction features that are directly embossed or patterned into either outer surface 58 or inner surface 60 of the light guide substrate 50. Other complementary layers, such as cover 88, mirror layer 82, adhesive layers. 86, and tissue interface layer 84 are shown for completeness. It also noted that the light guide bandages may include one or more optical layer 81, with spectral, polarization, diffusion or other potential optical properties which could enhance therapeutic use. Optical layers 81 could also have other desirable properties; and for example be photo-chemically active, and react (change color) in response to biochemically emitted light emerging from the tissue in connection to some, ongoing biological process. As such, other optical layers 81 could serve as a diagnostic device, similar to the previously mentioned biosensors.

It should be understood that the cross-sectional views of FIGS. 5a and 5b are meant to be illustrative of the general concepts, and do not represent the actual relative physical size of the various constituent layers and components. Other figures are intended to be similarly illustrative.

The previous FIGS. 4, 5a, and 5b are principally derived from the aforementioned commonly-assigned U.S. patent application Ser. No. 11/087,300 by Olson et al. The concepts described therein can be enhanced, in part from consideration of the nature of wounds and the modern wound care dressings used to treat them. In particular, the light therapy bandage 100 can be enhanced relative to both conformability and occlusivity. Additionally, there are opportunities to improve light efficiency, mechanical robustness, manufacturability, and safety of the device.

Although the device could be used to treat multiple conditions, the concept is principally linked to the treatment of wounds. Wounds are characterized in several ways; acute wounds are those that heal normally within a few weeks, while chronic wounds are those that linger for months or even years. Wounds that heal by primary union (or primary intention) are wounds that involve a clean incision with no loss of substance. The line of closure fills with clotted blood, and the wound heals within a few weeks. Wounds that heal by secondary union (or secondary intention) involve large tissue defects, with more inflammation and granulation. Granulation tissue is needed to close the defect, and is gradually transformed into stable scar tissue. Such wounds are large open wounds as can occur from trauma, burns, and pressure ulcers. While surgical wounds are typically stitched or stapled shut, which reduces the burden on the wound dressing, either a subsequent infection or wound geometry can shift the burden. While such a wound may require a prolonged healing time, it is not necessarily chronic.

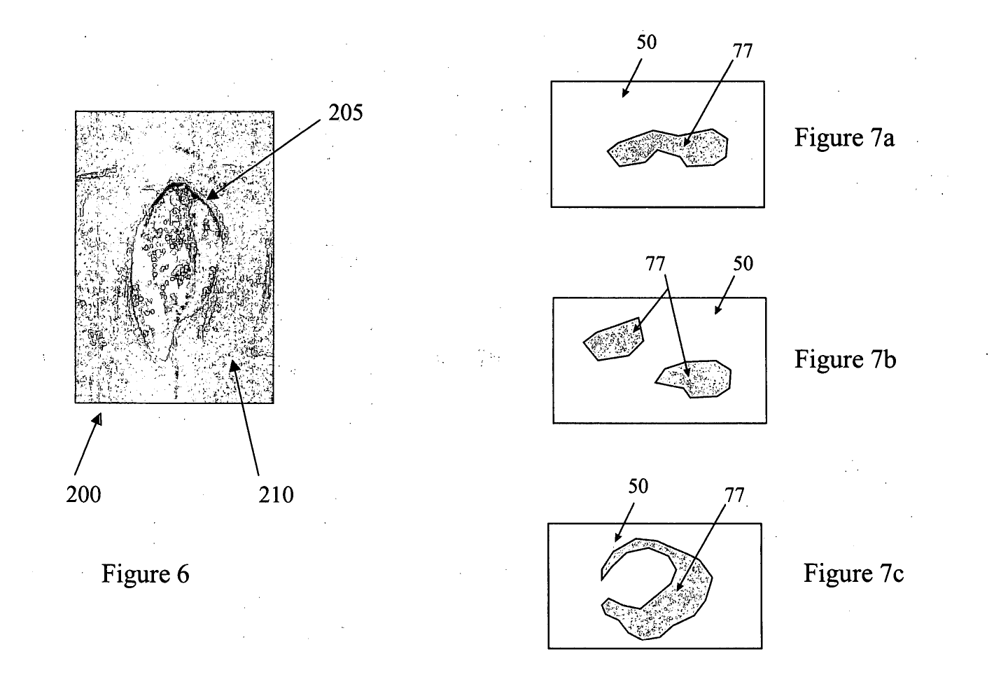

A chronic wound is a wound in which normal healing is not occurring, with progress stalled in one or more of the phases of healing. A variety of factors, including age, poor health and nutrition, diabetes, incontinence, immune deficiency problems, poor circulation, and infection can all cause a wound to become chronic. Typical chronic wounds include pressure ulcers, friction ulcers, and venous stasis ulcers. Stage 3 and Stage 4 pressure ulcers (see FIG. 6) are open wounds 205 that can occur whenever prolonged pressure is applied to skin 210 and tissues 200 covering bony outcrops of the body. Chronic wounds are also categorized, according to the National Pressure Ulcer Advisory Panel (NPUAP) relative to the extent of the damage:
Stage 1—has observable alteration of intact skin with changes in one or more of skin temperature, tissue consistency, or sensation (pain, itching). Pro-active treatment of Stage 1 and Pre-Stage 1 (also known as Stage 0) wounds could be beneficial.
Stage 2—involves partial thickness skin loss involving epidermis, dermis, or both. The ulcer is superficial and appears as an abrasion, blister, or shallow crater, much as depicted in FIG. 5a, where wound 205 penetrates the skin surface 210 and stratum corneum 225 and the epidermis 220.
Stage 3—Full thickness skin loss with damage or necrosis of subcutaneous tissue. FIG. 5b is generally illustrative of this type of wound, with wound 205 penetrating the epidermis 220 and the dermis 230, as well as a portion of the subcutaneous tissue 240.
Stage 4—Full thickness skin loss with extensive destruction, tissue necrosis, and damage to muscle, bone, or supporting structures (tendon, joint, capsule, etc.). Successful healing of Stage 4 wounds still involve loss of function (muscles and tendons are not restored).
Stage 5—Surgical removal of necrotic tissue usually required, and sometimes amputation. Death usually occurs from sepsis.

Wound healing also progresses through a series of overlapping phases, starting with coagulation (haemostasis), inflammation, proliferation (which includes collagen synthesis, angiogenesis, epithelialization, granulation, and contraction), and remodeling. Haemostasis, or coagulation, is the process by which blood flow is stopped after the initial-wounding, and results in a clot, comprising fibrin, fibronectin, and other components, which then act as a provisional matrix for the cellular migration involved in the later healing phases. Many of the processes of proliferation, such as epithelialization and angiogenesis (creation of new blood vessels) require the presence of the extracellular matrix (ECM) in order to be successful. Fibroblasts appear in the wound during that late inflammatory phase (˜3 days post injury), when macrophages release cytokines and growth factors that recruit fibroblasts, keratinocytes and endothelial cells to repair the damaged tissues. The fibroblasts then begin to replace the provisional fibrin/fibronectin matrix with the new ECM. The ECM is largely constructed during the proliferative phase (˜day 3 to 2 weeks post injury) by the fibroblasts, which are cells that synthesize fibronectin and collagen. As granulation continues, other cell types, such as epithelial cells, mast cells, endothelial cells (involved in capillaries) migrate into the ECM as part of the healing process.

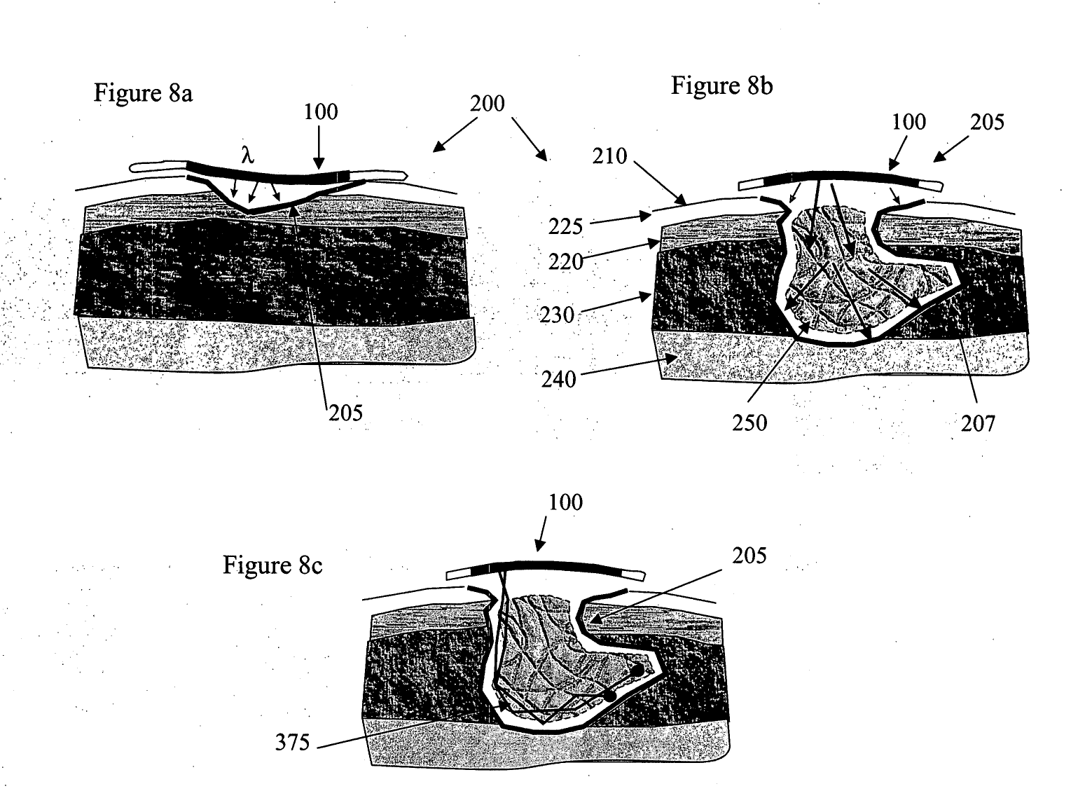

Stage 4 pressure ulcers can form in 8 hours or less, but take months or years to heal. Pressure ulcers are complicated wounds, which can include infection, exudates (watery mix of wound residue), slough (dead loose yellow tissue), black eschar (dead blackened tissue with a hard crust), hyperkeratosis (a region of hard grayish tissue surrounding the wound). Chronic wounds, including pressure ulcers, can evolve into a collection of multiple adjacent wound sites, which may be linked by hidden undermining or tunneling (an area of tissue destruction extending under intact skin). The general concept of undermining is illustrated in FIG. 8b, where there is a lateral extension of wound 205 under the surface of the intact skin. Although, for simplicity, FIG. 8b illustration shows this undermining 207 as being mostly confined within the dermis, it typically includes loss of the deeper subcutaneous tissues (fat, muscles, etc.) as well.

The use of bandages and dressings in wound care very much depends upon the circumstances. In the case of a shallow wound (as in FIG. 8a), a single dressing may be placed over the wound. Whereas, in the case of a deep cavity wound as in FIG. 8b, either acute or chronic, a primary dressing 250 may be inserted or packed into the wound, while a secondary dressing may be applied at the skin surface. As the wounds may have irregular shapes (as in FIG. 6), a light therapy bandage may need to provide light within one or more irregularly shaped light extraction areas 77, as shown in FIGS. 7a-7c. Modern wound dressings are designed with a recognition that optimal wound healing requires an ideal environment, including adequate exudate absorption, moisture vapor control, prevention of secondary infection, protection from external forces, thermal insulation for tissue temperature control, and easy use without harming the wound or the surrounding tissues. In particular, it is now understood that optimal (quickest, with least scarring) wound healing requires a moist, but not wet, environment. Generally, there are different expectations for different types of dressings. For example, a deep tissue packing dressing, such as an alginate or a hydrofiber dressing are available as sheets or ropes, and are used to absorb exudates and fill dead spaces. Whereas a thin film dressing is placed over the wound at the skin surface, and is required to control the access of moisture and bacteria to the wound. A thin film dressing may also have an attached foam or alginate wafer to provide moderate absorption of exudates. More generally, the properties of a wound dressing are defined relative to the “occlusivity” of the dressing, relative to being generally impermeable to bacteria and water (keeping them from getting into the wound), but being either permeable or impermeable (basically semi-permeable) to water vapor, oxygen, and carbon dioxide.

While intact skin has a low moisture vapor transmission rate (MVTR) of 96-216 g/m² day, the MVTR of wounded skin is much higher, at 1920-2160 g/m² day. A moisture occlusive dressing (used for a dry wound) has a low MVTR (<300 g/m² day), a moisture retentive dressing has a mid-range MVTR (<840 g/m² day), and a permeable dressing (used for a wet wound) has a high MVTR (1600⁺ g/m² day). In many cases, a thin polymer film provides the barrier properties that determine the occlusivity, and thus control the interaction between the tissues and the outside environment. The MVTR of a film depends on the film thickness, the material properties, and the film manufacturing properties. The bacterial occlusivity of a film depends on the size of the pores (for example, <0.2 microns) and the thickness of the film. Larger pores (0.4-0.8 microns) will block bacteria depending on the organism and their number, the pore size, and the driving pressure. Thus, the film thickness must be co-optimized, as a thicker film will beneficially preventbacterial penetration, but could then prevent sufficient moisture vapor transmission. Typical film dressings are thin elastic polyurethane sheets, which are transparent and semi-permeable to vapor, but have an outer surface that is water repellent. More generally, polyurethane is an exemplary moisture permeable film for a non-occlusive dressing is, and polyvinylidine chloride is an exemplary moisture impermeable film for an occlusive dressing. These continuous synthetic and non-toxic polymers films can be formed by casting, extrusion or other known film-making processes. The films thickness is less than 10 mils, usually of from 0.5 to 6 mils (10-150 microns). The film is continuous, that is, it has no perforations or pores that extend through the depth of the film. As a primary dressing, such film dressings are typically used for treating superficial wounds, including donor sites, blisters, or intravenous sites. For example, thin film dressings, such as Tegaderm from 3M, comprise a thin film with adhesive around the edge for attaching the dressing to the skin. A film layer can also be a component within a more complicated wound care dressing. For example, a foam dressing could combine an absorbent foam layer (to absorb exudates) with a thin film layer, to provide the needed occlusivity with the outside environment.

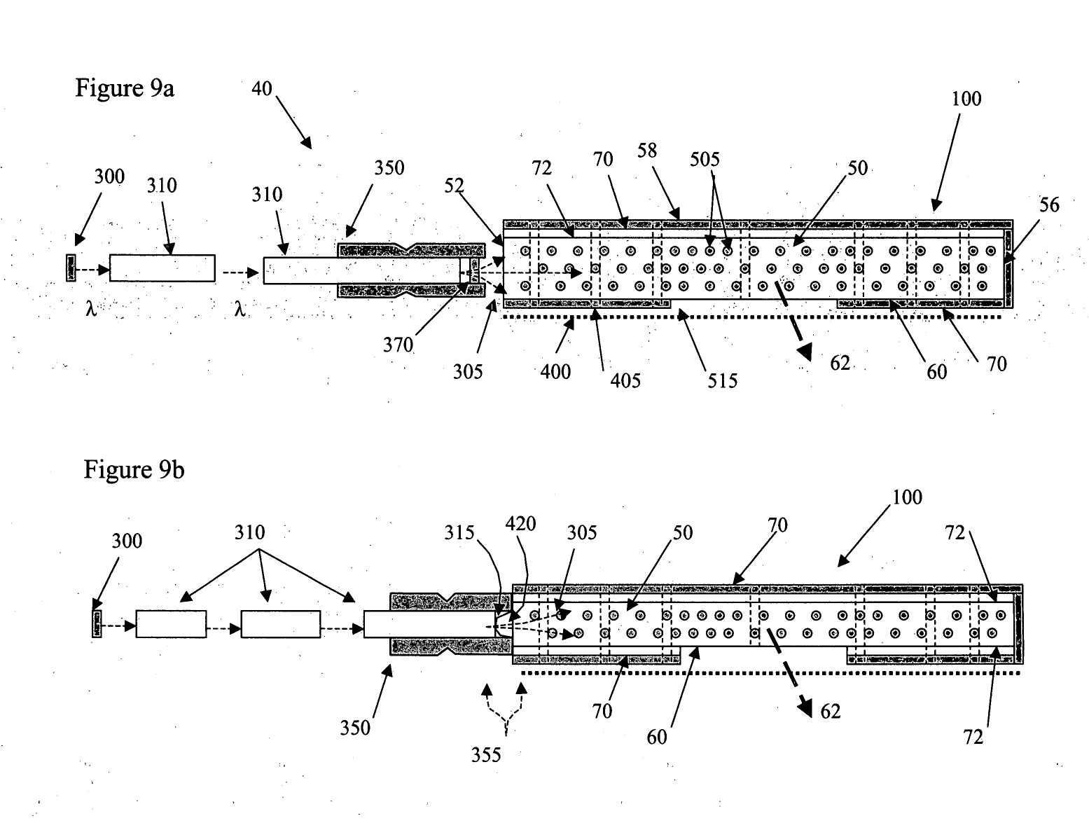

With the above understandings of wounds and wound care, it can now be appreciated that the light therapy bandage 100 of FIG. 9a can be equipped with a barrier layer or porous membrane 400, which can be a polyurethane thin film sheet which defines the occlusivity of device 100 relative to MVTR, bacterial access, and other properties. For example, barrier layer 400 could have a moderate MVTR appropriate for use with a moderately exuding wound. As such, it would allow a fair amount of moisture to evaporate out of the wound, in order to help optimize the wound moistness and healing. Barrier layer 400 could either be permanent with substrate 50, or removable, and perhaps replaceable. Barrier layer 400 could also be provided between substrate 50 and the inner side reflector layer 70, but that could complicate bandage fabrication or use. However, it may not be sufficient to equip light guide bandage 100 with barrier layer 400 attached to exit surface 60, as moisture could otherwise be trapped within the structure, as substrate 50 is likely too thick (1-3 mm) to allow effective moisture vapor transmission. The trapped moisture could condense within the bandage and then impair device function or become a breeding ground for bacteria. Thus, bandage 100 is provided with a multitude of vapor channels 405 which are nominally orthogonal to the large sheet-like surfaces of the bandage 100. However, vapor channels 405 could also run laterally with the bandage towards the edges of the bandage. The diameter and shape of the vapor channels should be such that the moisture vapor can exit relatively unencumbered through these channels, thus allowing the barrier properties to indeed be defined by layer 400. Vapor channels 405 are nominally extended through the top layers (such as reflector 70) of substrate 50, to enable moisture vapor transfer. If the outermost layers had high (non-limiting) MVTRs the channels 405 could stop short of the outer surface of the bandage. Barrier layer 400 could also be a multi-layer structure, having for example an inner layer proximal to the tissue, with barrier properties (such as a low MVTR) and a outer layer facing towards substrate 50, with a high MVTR, which could assist the moisture vapor in traveling laterally to reach the vapor channels 405.

Of course, as wound dressings are used in myriad ways and combinations, a circumstance may arise where light therapy bandage 100 is provided without a barrier layer 400, as that function is provided within another (primary) dressing. It should be understood that an absorbent layer, such as foam sponge or alginate pad could be attached to bandage 100, for example between the barrier layer 400 and the underlying tissue being treated. Of course, as bandage 100 is intended for use in light therapy, this absorbent layer should be nominally transparent as well. However, as some wound care dressings, such as those using alginates and hydrofibers, become transparent when wet, this is achievable. Additionally, and somewhat surprisingly, exudates, which principally comprise water, are generally transparent, or only moderately discolored. So, again, reasonable light transmission into the wound is possible. Thus, as illustrated by FIG. 8b, therapeutic light (λ) could propagate through a primary dressing 250 and be incident on the deeper tissues.

Many of the primary elements of light therapy device 40 are represented in FIG. 9a, including the light source 300 (likely resident in controller 20, not shown), optical fiber 310, bandage 100, and barrier layer 400. Light source 300 may be single light emitter, but is likely a multitude of emitters, and in particular, is likely a multitude of optical fiber pigtailed laser diodes. However, light source 300 can comprise lasers (solid state, diode, fiber laser, etc.), LEDs, super-luminescent diodes (SLDs), an arc lamp, or other possible light emitters. The therapeutic light can be of one or more wavelengths in the ultraviolet, visible, or near infrared spectra, but is preferably red or near infrared light (600-1300 nm).

It is noted that FIG. 4 depicted light therapy device 40 as having a simple fiber optic cable 12 as a light conduit. However, the reality is likely much more complicated. As stated previously, light therapy device 40 is generally intended to have a modular design that would enable flexible patterns of use. For example, it may desirable for the light therapy bandage to be left in place on the patient between treatments. Therefore it is desirable to be able to disconnect the fiber optic input from the bandage. This connection point could be at the input surface 52 of the substrate 50. However, as the bandage 100 may become contaminated during use, and then the attached fiber optic cable 12, a modular intermediate assembly is useful. Thus, as a further detail, FIG. 9a depicts light source 300 supplying light via optical fiber 310, which is shown in two portions, the latter of which is held within intermediate assembly 350. Optical fibers 310 may be fiber bundles or fiber arrays, but are shown in cross sectional simplicity as single fibers. Fiber optic connectors (not shown) may be used to hold the first and second optical fibers 310 together for efficient light coupling.

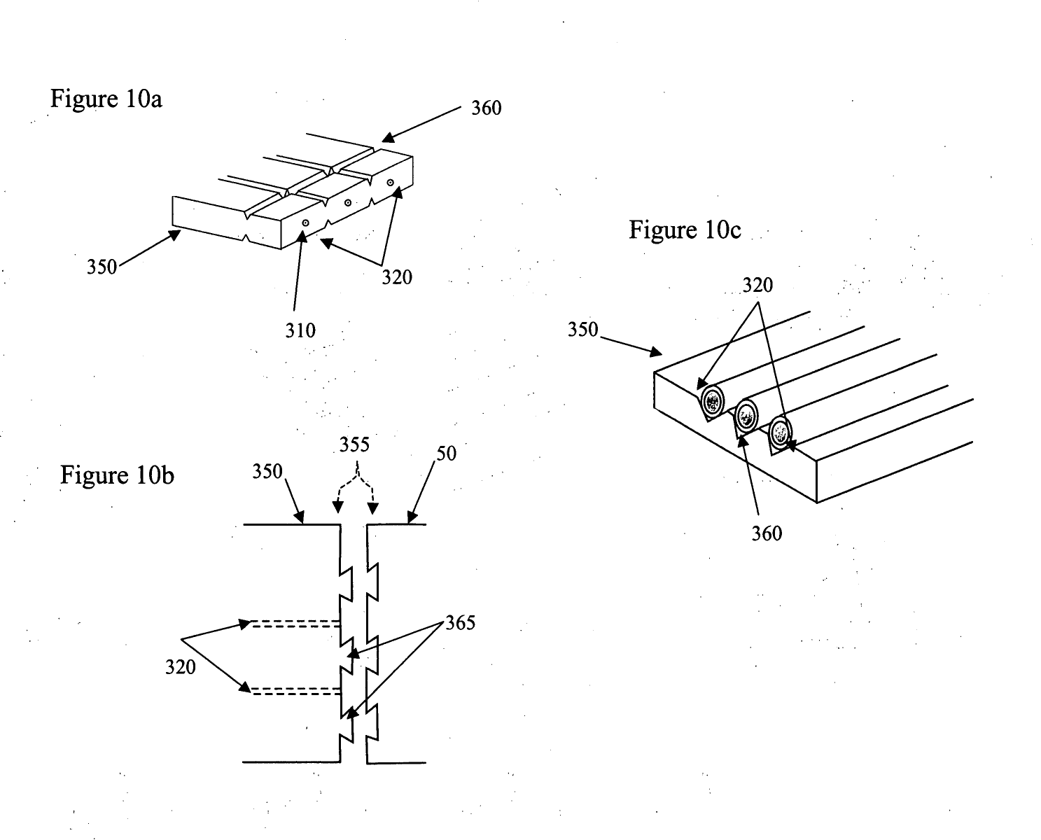

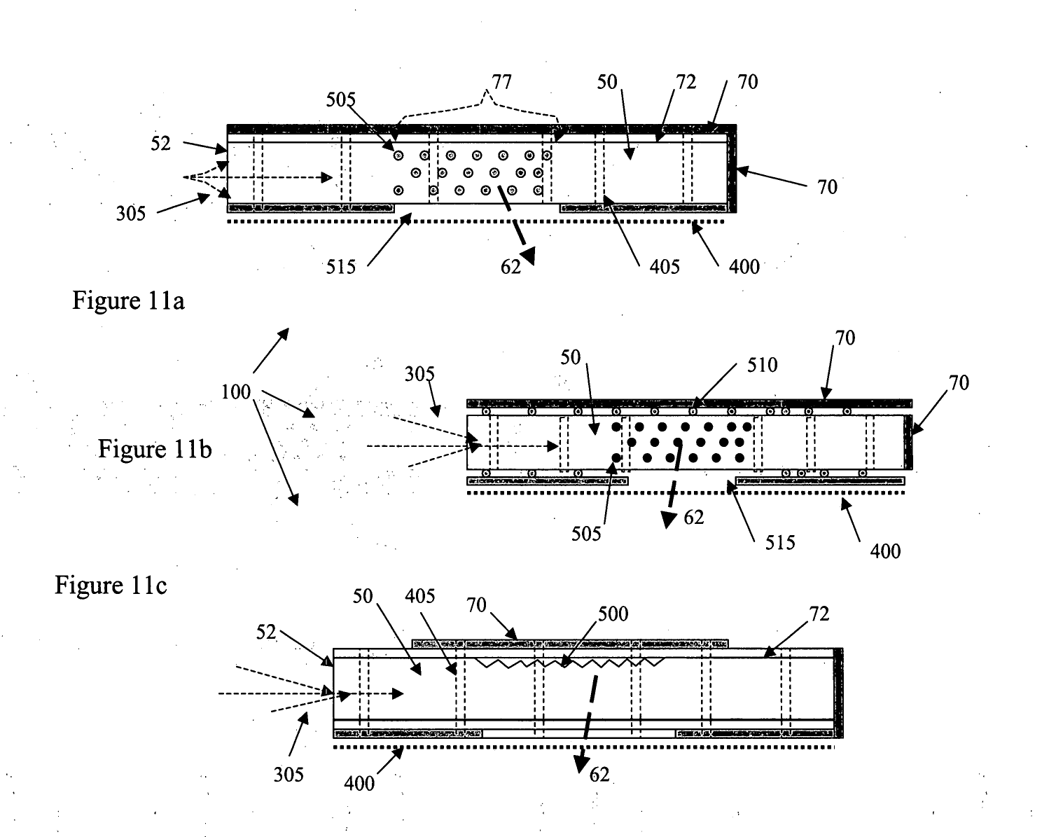

Intermediate assembly 350 could be a light guide (planar dielectric sheet), but is preferably an assembly with a series of imbedded optical fibers. Intermediate assembly 350 must provide a robust optical coupling with both the light guide substrate 50 and the input optical fibers 310. For example, as the patient may rest on the light therapy dressing 100 during treatment, intermediate assembly 350 must be flexible; and yet link to substrate 50 with a robust low profile connection that minimizes both disconnects (loss of light efficiency) and pressure points (minimize patient discomfort). FIG. 10a shows an exemplary illustration of the end of intermediate assembly 350 that is proximal to the light guide substrate 50. For example a fiber optic cable carrying numerous optical fibers could interface with intermediate assembly 350 with one or more fiber connectors. An array of optical fibers 320 is imbedded in intermediate assembly 350, which could be fabricated from a flexible non-toxic polymer'such as polyurethane. Intermediate assembly 350 can also have a series of grooves 360 which can flex to enhance the ability of the assembly 350 to move in concert with substrate 50. As the optical fibers 310 are likely large core (˜60-200 μm) plastic multimode fibers, and substrate 50 likely has a thickness (T) of 150-500 μm, the transverse (Y) alignment is not critical. A robust low profile connection of intermediate assembly 350 and light guide substrate 50 can be accomplished in numerous ways, including with clamping mechanisms. FIG. 10b illustrates one approach for the input interface 355, which is to provide mating features in the end surfaces, such as dovetail extensions and slots 365, which could supply positive pressure to hold the two components together. On the distal end of intermediate assembly 350 (towards the light source), it is important to have a robust interconnection with the input fiber optic cable 12. As one example, FIG. 10c shows that intermediate assembly 350 could have the optical fibers 310 of optical fiber array 320 assembled into a series of grooves 360, where grooves 360 act as V-groove alignment features. Fiber optic cable 12 could end with a similar fiber array mount, and the two pieces could be held together with mating housings (not shown). Again, with the use of large core multimode optical fibers, the alignment tolerances should be easily attained.

The input interface 355 of intermediate assembly 350 may include other features to improve device performance. For example, an input coupling optic 370, such as lens or diffuser (circular or elliptical), could be included to fan the light out into the light guide substrate 50 to enhance uniformity and efficiency. However, the surface quality of the input surface 52 can dramatically affect the input light coupling. For example, if substrate 50 is manufactured with a cutting process, this surface can be fairly rough. The input surface 52 could be treated post-cutting with a solvent in order to smooth it out. Alternately, an optical coupling index matching liquid or gel 420 could be placed at input interface 355, filling the gap between the fiber end 315 and substrate 50, as is shown in FIG. 9b.

As would be expected, the performance of bandage 100 is very dependent on both the input light coupling and the light extraction means. FIG. 9a depicts a concept for bandage 100 in which scatter beads 505 are strewn throughout the volume of substrate 50. Input light is diffused within substrate 50 by multiply scattering from beads 505, with therapeutic light 62 exiting through aperture 515. Scattered light that passes through TIR layer 72 can be captured by reflective layer 70, and directed back into the substrate 50. FIG. 9b shows a version in which a cladding like TIR layer 72 is also provided on the inner surface 60 of substrate 50. However, scatter bead refractive index, size, density, and spatial distribution, as well as substrate absorption, become critical. For example, if the scatter beads have too little side and backscattering, little light will exit out aperture 515. But if there is too much back and side scattering, the light efficiency can drop. In the case of the FIG. 9a concept, if reflective layer 70 is a metallic coating, so much light is lost within the light guide that the light efficiency can be quite low (˜25%), and the exiting light tends to be localized towards the input side. The number of input sources (fibers at the input surface) also has an impact on efficiency, as with more sources, the beads can provide less scattering to obtain uniformity over the output aperture 515. As another factor, the index difference between the TIR layer 72 and the substrate is likely a modest Δn˜0.09. Thus, the critical angle for TIR is relatively high, and significant light can interact with reflector 70. As a result, even if the reflector 70 is a highly reflective material, such as the 3M-ESR film, the losses accumulate.

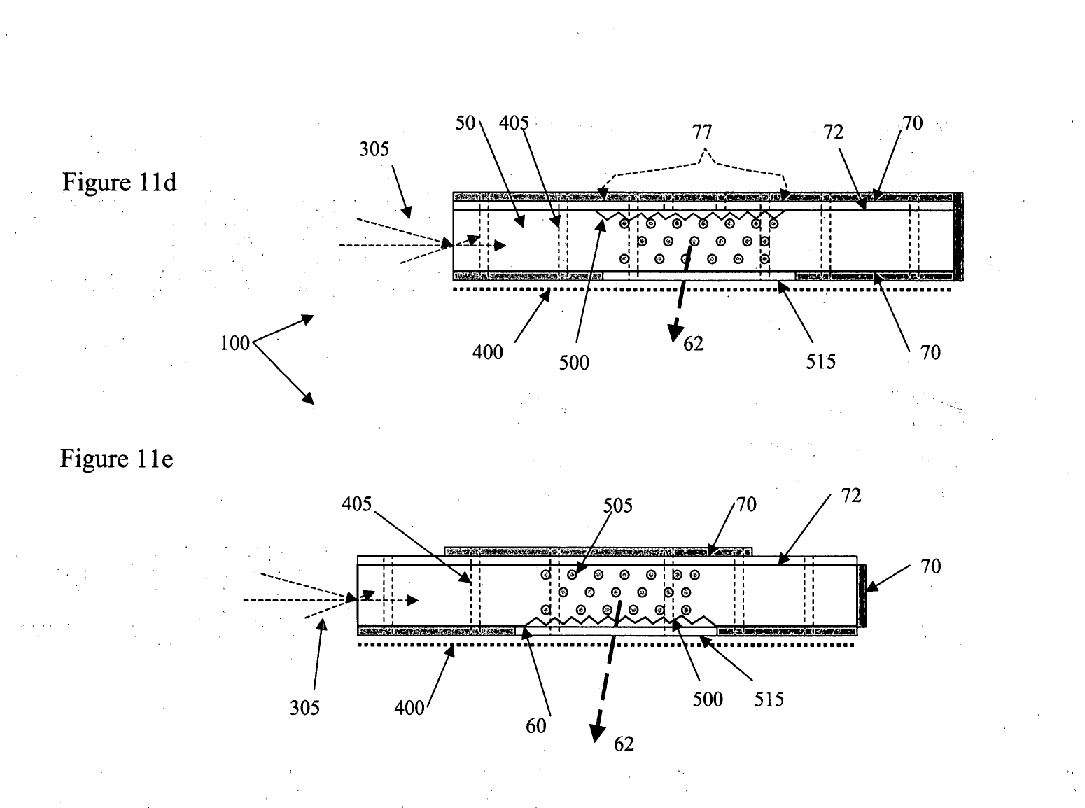

FIG. 11 a shows a potential alternative, in which the scatter beads 505 are localized about the output aperture 515 of light guide substrate 50, which means the bead size can be optimized for greater backscattering by using a smaller bead size. This approach helps the light efficiency, as there are fewer scattering events and fewer reflections off of the reflective material 70. Also, with light extraction localized over the aperture 515, there is less need for a cladding TIR layer on the substrate 50 surfaces, as there is less light interacting with the substrate edges at locations further removed from aperture 515. As a further light efficiency improvement, if the TIR layer 72 of FIG. 11a is replaced by air, with the reflective material 70 offset from the substrate 50 by spacer beads 510, the light guiding capability of the substrate 50 is enhanced, which reduces interactions with reflective material 70. This version is shown in FIG. 11b. Modeling with 2-3 μm diameter scatter beads, 25 μm spacer beads, and Δn˜0.09, suggests that the output light efficienty can be 60%. While the scatter bead concept is attractive relative to web fabrication, web coating with spatial localization of the scatter beads may be non-trivial. Additionally, the light emerging from aperture 515 tends to be an uneven distribution at high angles, rather than emerging in an even light distribution about an axis orthogonal to substrate 50. The design approach with the reflector 70 offset by spacer beads 510 (or other shaped spacers) could have its performance impaired if pressure is applied to the bandage 100 such that the reflector 70 ends up in intimate optical contact with the substrate 50, thereby defeating the TIR condition.

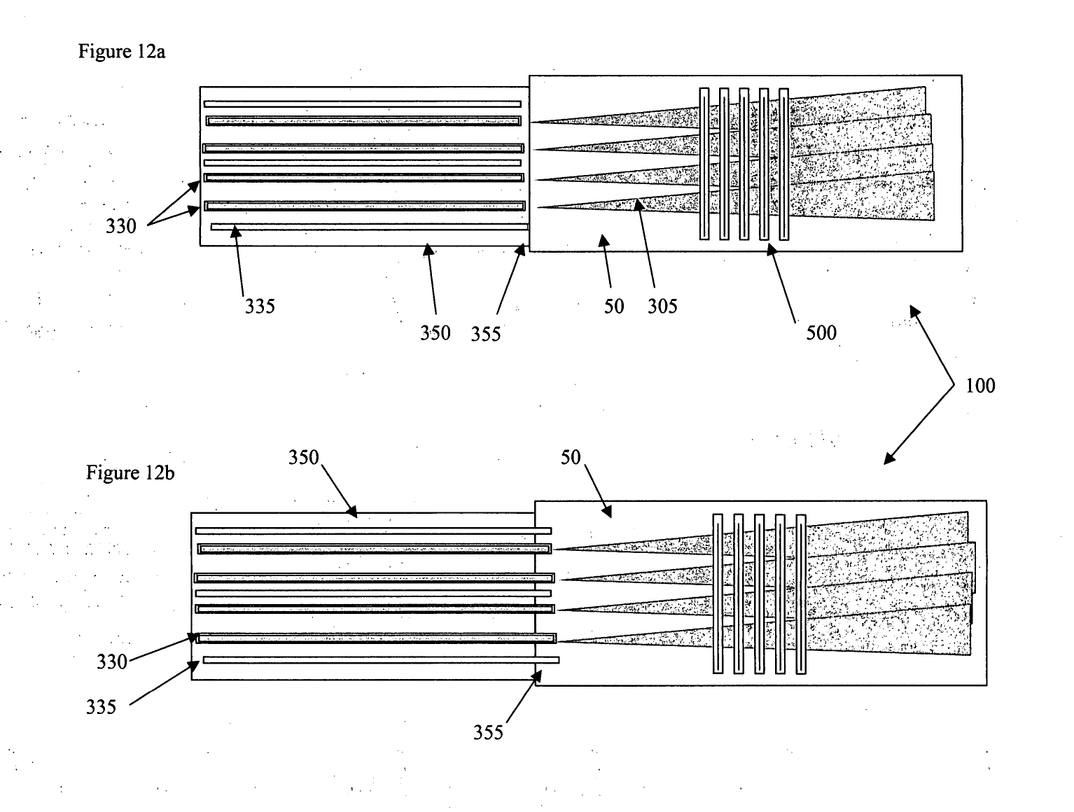

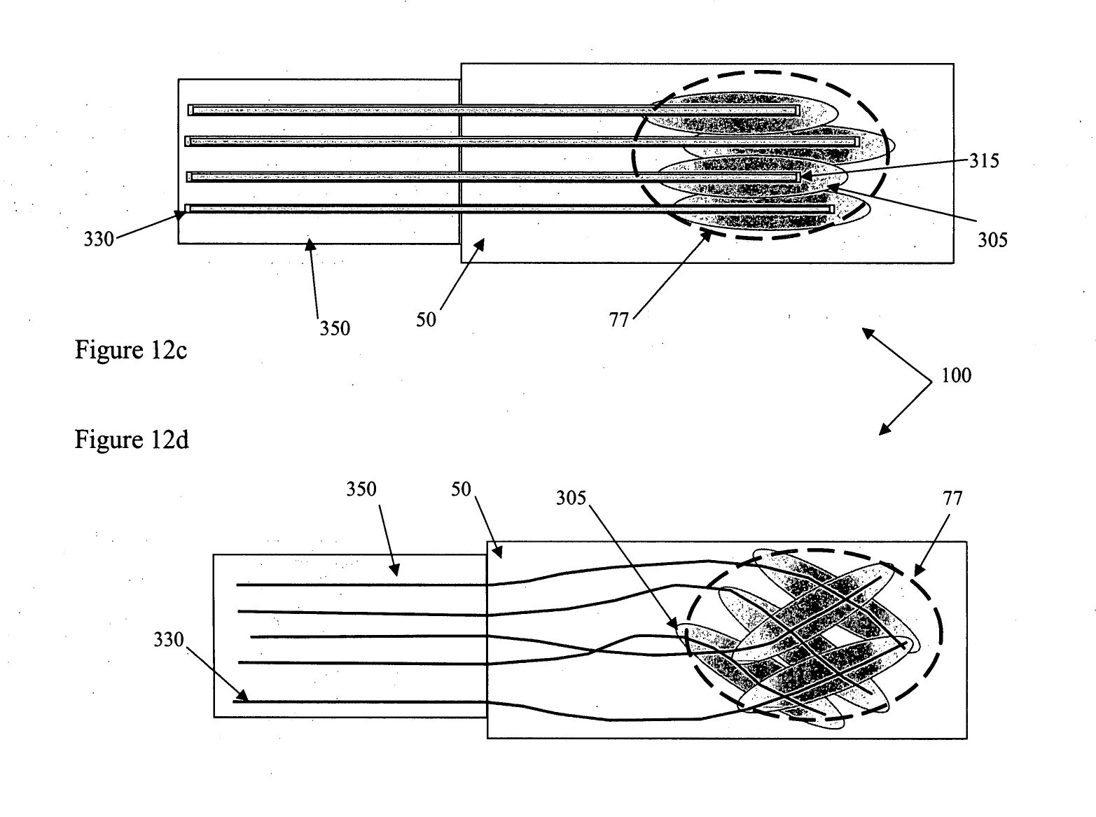

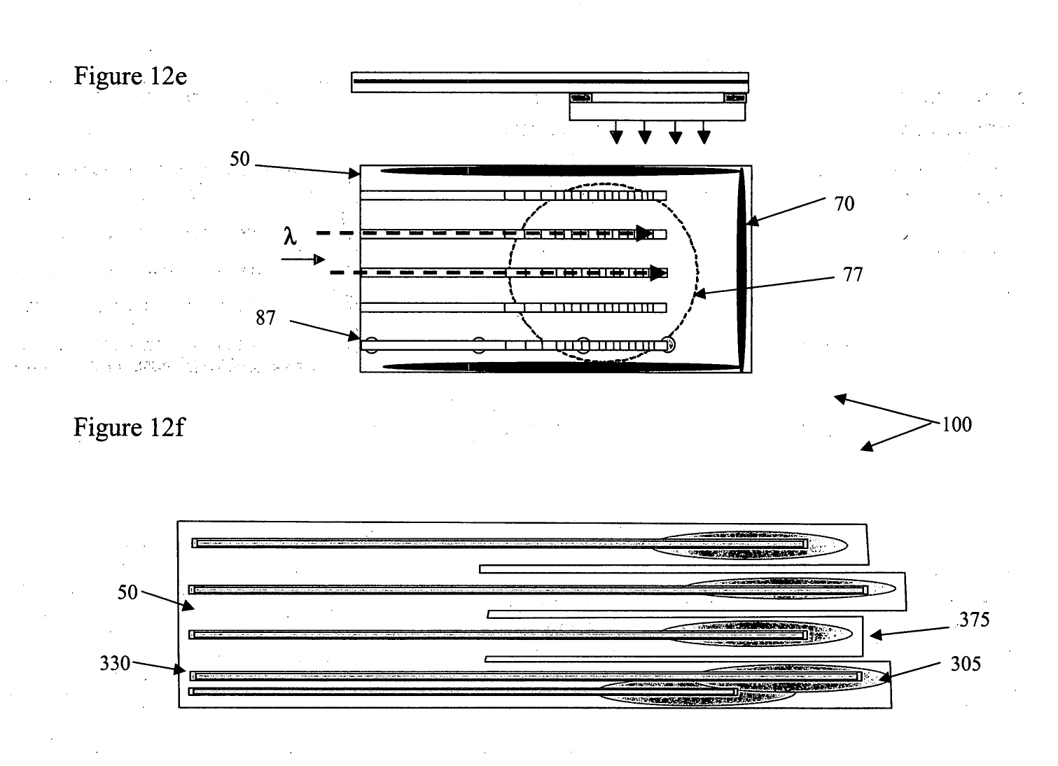

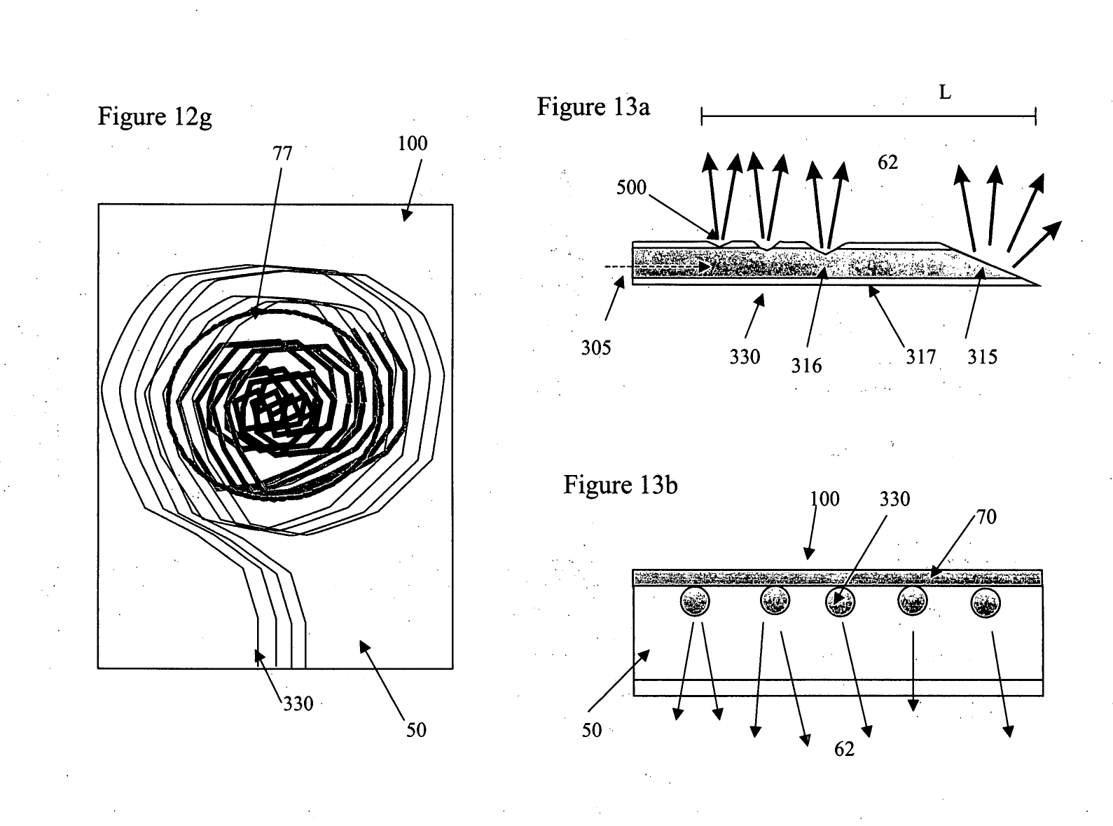

Alternately, the light guide substrate 50 can be patterned or embossed with light extraction features 500. This is somewhat similar to applying the 3M BEF film,-except that embossing could be very cost effective for a high volume manufacturing operation, such as one using web processing methods. FIG. 11c shows the side view of an approach where light extraction features 500 are provided on the outer surface 58 of substrate 50. This general approach is shown again in top view in FIG. 12a, where input light 305 fans out within substrate 50 and encounters light extraction features 500, which are optical micro-structures, typically 3-50 microns in size, which scatter, refract, reflect, or diffract the incident light. Light extraction features 500 can be either formed into the substrate 50 by embossing or other means, or formed on top of substrate 50, such that they protrude from the outer surface 58. Reflective material 70, which again can be an ESR film, is provided to redirect light that is escaping from the outer surface 58 back into the light guide substrate 50. For example, the light guide was modeled with light extraction features 500 as inset grooves in substrate 50, having 25 μm width and 10 μm height, with a resultant light extraction efficiency of ˜75%. The features 500 would be spaced irregularly across upper surface 58, with greater density at distances-further from input surface 52, to improve the uniformity of light extraction. As shown in FIG. 11d, the patterned light extraction features 500 could be used in combination with scatter beads 505 for enhanced light extraction. Likewise, as shown in FIG. 11e, the patterned light extraction features 500 can be put on the inner surface 60 of light guide substrate 50.

FIGS. 11c-11e also show that bandage 100 could have a patterned film on the inner side of substrate 50, which would be light reflecting except at aperture 515, where the film would be transparent and function as a window. This in comparison with the prior figures, where aperture 515 was basically illustrated as a hole through the film or films which are attached to the inner surface 60 of substrate 50. Of course, a given bandage 100 could be provided with multiple apertures 515 supplied with light via a single light extraction area 77 or multiple areas 77, so that multiple adjacent wound sites can be treated (see FIG. 7b). In general, bandages 100 would likely be supplied with pre-fabricated light extraction areas 77 and aperture 515, and a clinician would select a bandage with the best match to the wound site. However, it may be possible to make the bandages 100 customizable. For example, bandage substrates 50 could be supplied with pre-fabricated light extraction areas, and assorted patterned films with apertures 515, where a clinician selects (and perhaps alters) the aperture/reflector film, and-then assembles it to substrate 50.

As before, vapor channels 405 would be provided through a transparent window film. In the case that there are patterned light extraction features, either from an applied film (such as BEF) or from embossing or other means, at the inner surface 60, there is a concern that moisture vapor could be trapped and condense in these features and effect the light extraction. By comparison, if the patterned light extraction features 500 are at the outer surface 58, as in FIG. 11d, moisture vapor emerging from vapor channels 405 has a short distance to travel through any overlaying films in order to escape. Moreover, additional vapor channels could be provided at the light extraction area 77 to assist vapor transport out of the bandage 100.

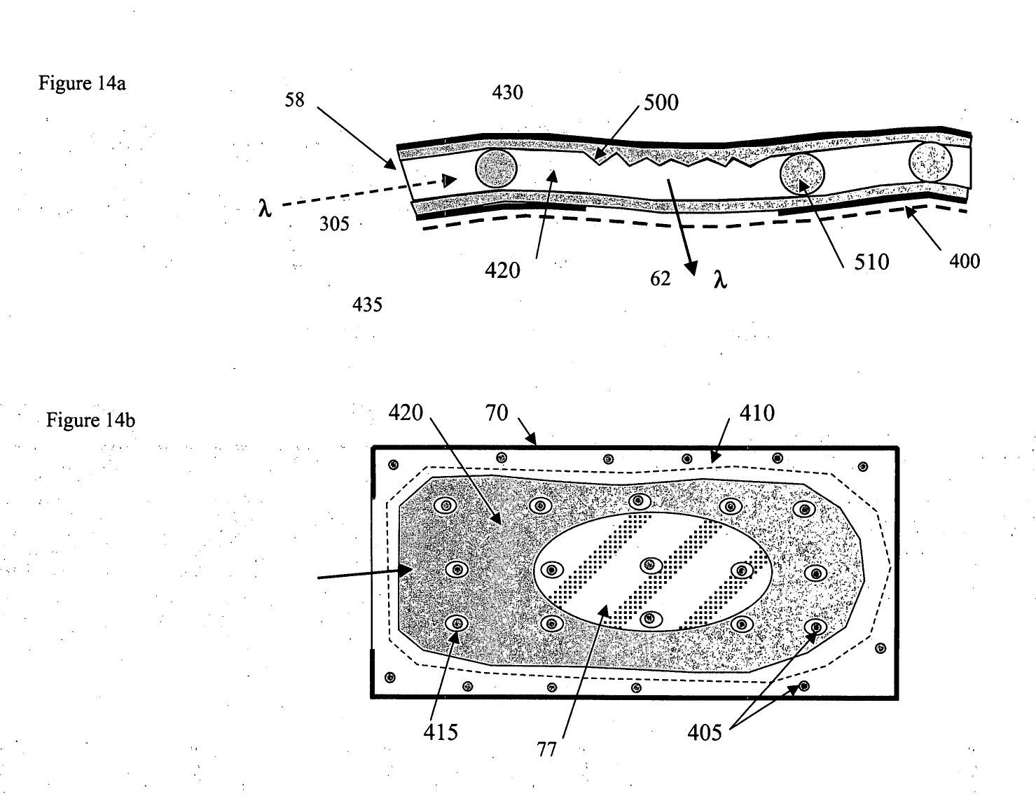

As previously discussed, FIG. 12a depicts a top view of input light 305 fanning out within a light guide substrate 50 to encounter light extraction features 500. In this illustration, the input optical fibers 330 stop at the edge of intermediate 350 and are basically butt coupled to light guide substrate 50 at interface 355, with the potential assistance of an index matching liquid or gel (420). While the interface 355 between the intermediate 350 and the substrate 50, using index matching, positive pressure features such as dovetails 365 (see FIG. 10b) is plausible, there are other opportunities an approaches. For example, as shown in FIG. 12b, input optical fibers 330 could protrude or extend into the substrate 50. For example, if substrate 50 had a core portion that comprised a clear optical foam or gel (as will be discussed later relative to FIGS. 14a and 14b), then the intermediate assembly 350 could be introduced and removed along with input optical fiber 330. However, in this case, input optical fibers 330 would be vulnerable to damage. So, as an alternative, the intermediate assembly 350 and substrate 50 could be integrated into a whole; The intermediate assembly 350 would lose its modularity and function as a bandage extension, but it could still separate controller 20 and fiber optic cable 12 from the dangers of damage and contamination.

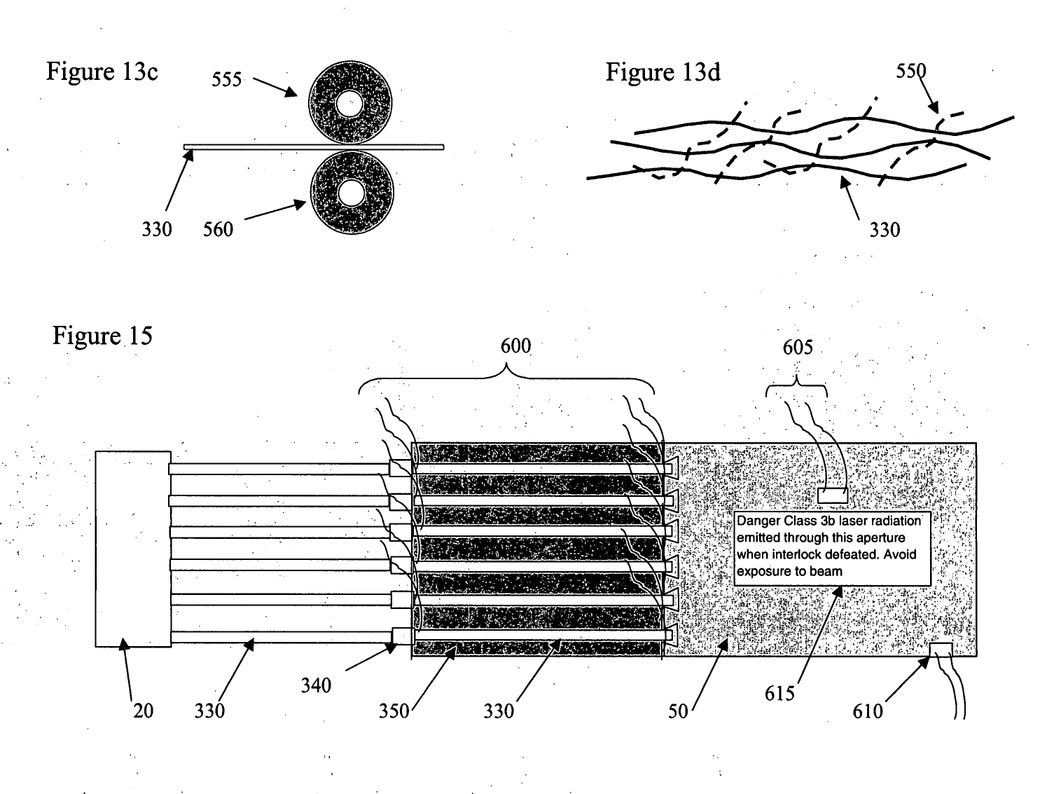

As a further alternative, input optical fibers 330 could be inserted or imbedded into substrate 50 and extend to the intended light extraction area 77, as is depicted in FIGS. 12c, 12d and 12e. The initial light delivery into the light extraction area 77 could be accomplished by having some number N of optical fibers by the imbedded optical fibers 330. This light would propagate out of the end of the fibers, bounce around in the light guide, and then find its way out an exit aperture 515. The various side surfaces (52, 54, 56, 58, and 60, as shown in FIG. 4) would again be provided with reflecting coatings or layers as needed, to contain light within substrate 50, thereby increasing light efficiency. Likewise, the light guide substrate 50 could again be equipped with light diffusion layers, brightness enhancement films, or other optics to affect the directionality and light efficiency of the bandage. However, while the imbedding of the fibers 330 is a difference between the bandage concepts of FIGS. 12c-12e and the prior examples (FIGS. 9a, 9b, 11a-11e, 12a, and 12b) in which the input light propagates a significant distance within substrate 50, there is a further important difference. In particular, as shown in FIG. 13a, the exterior surfaces of input optical fibers 330 can be altered to create light extraction features 500, which effect the cladding 317 and core 316 and thus allow input light 305 to leak out from the fiber core 316 over some length (L) to provide therapeutic light 62. This combination of imbedded optical fibers 330 having a pattern of light extraction features 500 on a side of the fibers, can generally deliver light more efficiently to a light extraction area 77 than can the prior versions where the input light initially propagates into substrate 50 at or near input surface 52.

As shown in FIG. 13a, these light extraction features 500 are depicted simplistically as groove type optical microstructures. Indeed, processes such as embossing, abrading or nicking, chemical etching, thermal ablation, or other means could be used to create physical grooves or notches on a side of fibers 330. Although the groove-like light extraction features 500 are depicted with clean cross-sectional profiles, the surface alteration process may leave residual materials mounded to either side of the features 500, which may effect the outgoing light distributions. The light extraction features 500 can also be provided as localized changes in fiber refractive index (via a diffusion process) or as diffusing micro-fractures (cladding and core basically roughened via various mechanical processes). In these cases, the light extraction features 500 would not appear as grooves or notches as shown in FIG. 13a. The depth, width and spacing of these light extraction features 500 should be determined to provide a nominally uniform light leakage from the fibers over some fiber length. As an example, the fiber jacketing (not shown) which surrounds the cladding 317 would be stripped away to leave a length of fiber where the cladding is exposed. Input optical fibers 330 could then be processed through a machine with a hot embossing drum 555 and an opposing drum or roller 560, much as depicted in FIG. 13c, to impart patterns of light extraction features 500 to the fiber surface. Then the patterned optical fibers could be assembled into bandage 100 (see FIG. 13b) in an exemplary process that attached the fibers 330 within substrate 50, with the goal that the light from each fiber nominally exits normal to the bandage within the light extraction area 77, to form therapeutic light 62. For example, fibers 330 could be fixed within a substrate 50 comprising a polymer material such as a polyurethane, and then a reflective material 70 (such as an ESR film or coated Mylar film) and porous membrane 400 would be applied thereafter.

The light extraction from optical fibers 330 via light extraction features 330 can depend on the refractive index of the surrounding material of substrate 50. As an example, if the light extraction features 500 are groove like structures, than substrate material will fill the grooves. If the substrate refractive index is less than the refractive index of core 316 (nₛ<n_{c}), then the majority of the light is emitted towards the far end of the input optical fibers 330. This because the light has a greater tendency to stay confined within the fibers, and then a TIR retro-reflection from the fiber end 315 contributes to an accumulation of light intensity near the fiber end. Whereas, if the substrate material refractive index is greater than the index of the fiber core 316 (nₛ>n_{c}), then the intrusions into the cladding and core create disruptive phase objects. The greater the difference in index (such as Δn˜0.05-0.10), the more quickly the light leaks from the input optical fibers 330. The light extraction features have been described generally as macro features, which may use light refraction or scatter to extract light from the optical fibers 310. As such these features are large, and for example may be 0.5 mm or more in length, and spaced apart by several mm. Feature size and spacing may be adjusted along a length of the input optical fibers 330 to enhance uniformity of light extraction. However, each light extraction feature 500 may alternately comprise a smaller structure of sub-features, provided on a scale of multiple wavelengths. In effect, each light extraction feature 500 may be a phase grating, which enables-light extraction via diffraction rather than refraction or scatter. Also as further shown in FIG. 13a, the fiber:end 315 can be cut or cleaved to bias the direction of light emission from the fiber end 315 in the same direction as the light emitted from the side of the fiber (for nₛ>n_{c}). Thus, FIGS. 12c and 12d show the input light 305 as overlapping fans of light emanating from the input optical fibers 330 over some length of each fiber.

As discussed previously in the background, there are light therapy pad devices comprising woven fiber optic mats, such as the devices offered by Respironics. However, these pads provide no means to localize the light treatment, as can be useful for a light therapy bandage. FIG. 12g shows an alternative, where the input optical fibers 330 are attached to or imbedded in substrate 50 and are coiled in an edge to center spiral and overlaid. As the fiber coiling or bend becomes smaller, more light will leak from the fibers, generally towards the center of the substrate 50. However, the light will tend to leak from the fibers in the plane of the substrate 50, rather than orthogonal to it. To modify this, cross woven fibers 550 can be used, as shown in FIG. 13d, to create micro-bends. Unlike the prior art woven fiber devices, the cross-woven fibers would be provided only within the light extraction area 77 where the coiled fibers are centered, and not in the outer portions of the bandage 100. While this approach can work, it offers less control of the light emission from the input optical fibers 330, as well as a more cumbersome construction, as compared to the imbedded fiber devices of FIGS. 12c-12e.

With respect to the design of a light therapy bandage, conformability is a particular concern, as a clinician may need to use the device 300 in a difficult location, such as at the lower back/buttocks, or even within an undermined wound or body cavity. While conformability design issues have been discussed relative to intermediate assembly 350, there are design considerations for the substrate portion of bandage 100 as well. For example, as shown in FIG. 12d, the input optical fibers 330 can be distributed semi-randomly, in a serpentine fashion, in order to improve multi-directional flexibility. As another consideration, substrate 50 has been generally described as comprising a flexible transparent polymer sheet, such as a polyurethane. However, substrate 50 could comprise a multi-layer structure, using a transparent gel or foam, to enhance conformability over a solid material. FIG. 14a illustrates the general case, wherein substrate 50 comprises a material 420 assembled between an upper layer 430 and a lower layer 435. For example, material 420 could be an optically transparent gel, which is encapsulated or sealed between the upper and lower sheet materials 430 and 435. Spacer beads 510 could be used to keep the overall thickness of substrate 50 nominally constant, even if pressure is applied to the bandage 100. As shown in FIG. 14b, the upper and lower sheet materials could be welded towards the bandage edges to form a seal 410 to keep the gel contained. These two sheets could also be welded together by welds 415 scattered across the bandage 100, which would keep the gel from collecting locally. Vapor channels 405 could be provided through the middle of welds 415.

Gel material 420 would need to have a higher refractive index than the upper and lower sheet 430 and 435, so that substrate 50 will function as a light guide. It is generally assumed that transparent gel material 420 must be kept out of the wounds, in order to not unintentionally alter the wound environment. The encapsulated transparent gel material could be a moisture absorbent wound treatment gel, such as a hydrocolloid gel (Douderm from Convatec, for example) or an alginate gel. A wound treatment gel could also be applied onto barrier membrane 400, between membrane 400 and the tissue (not shown), to provide moisture absorption before the exudates reach the membrane 400. Such gels are not meant to be tacky, as wound dressings are designed to avoid adhesion with the wounded tissue, so as to avoid causing further damage to the wound site.

As mentioned, material 420 could also be a polymer foam material, such as a solvent-coated polyurethane or a Dow Corning clear optical RTV. Again the foam material 420 would need to-have a higher refractive index than the upper and lower sheet 430 and 435, so that substrate 50 will function as a light guide. With a foam material, spacers 510 and welds 415 may not be needed, as a foam, unlike a gel, will neither pool or leak into the wound. However, welds 415 could still be useful for routing through the vapor channels 405, so that the moisture vapor cannot collect within the foam. It may be helpful to minimize foam cell size, to reduce contamination issues within bandage 100. On the other hand, the vapor channels 405 could be routed directly through the open cell foam, if that foam was to be used for absorption. Either approach, with substrate material 420 comprising a gel or foam, can be used with the imbedded fiber (FIGS. 12c-12e) concepts. The refractive index of the foam or gel is not then restricted by a light guiding requirement. However, the refractive index of this substrate material should minimally impact the effect of the light extraction features patterned on the side surface of the input optical fibers 330 (see FIG. 13a).

In the field of light therapy, there is significant uncertainty regarding the optimal dosage conditions relative to wavelength, intensity, coherent or incoherent light, CW or pulsed light patient responsiveness, etc. The reported light intensities range from ˜5-50 mw/cm², with ˜10 mw/cm² being a typical value. With that latter value, a 70 mm diameter aperture 515 would correspond to ˜40 cm² or 400 mw therapeutic light 62 incident to the tissue. Allowing for 50% light efficiency in a light guide, as well as various coupling losses between the light sources 300 and the substrate 50, then ˜2-3 W of light source optical power could be required. The imbedded fiber bandages 100 of FIGS. 12c-e would likely be more light efficient, and may only need <1 W of light source optical power to provide the same 400 mw out. With these power requirements, and the desire for red and IR light and low cost, light source 300 is likely a multitude of fiber pigtailed laser diodes. For example, 0.5 W fiber pigtailed IR emitting laser diode assemblies can be commercially purchased for <$200 apiece. Thus, the light source 300 for the light guide bandage could comprise 8 fiber pigtailed 0.5 W lasers. Whereas, the light source 300 for the imbedded fiber bandage could comprise 12 lower cost 100 mw fiber pigtailed IR laser diode assemblies. In either case, the laser diodes are likely either class IV or class IIIb laser sources, which means that light therapy device 40 is subject to various regulatory restrictions. To some extent, these issues are mitigated by the fact that the light emerging from aperture 515 is low power and no longer spatially coherent. However, various safety measures may be required, as high power invisible (IR) laser beams are present at least in the optical fibers, and could they cause eye damage if they leaked from the device, particularly from the interconnects.

Thus, FIG. 15 depicts a light therapy device 40 with a series of interlocks and cabling, at least one optical power monitor 605, a bandage interlock 610, and safety signage 615. For example, interlocks 600 could be electrically active sensors that would detect the status of fiber connectors 340 at intermediate assembly 350. Optical power monitor 605, which could be a low profile thin film device, could check for operating power stability and continuity. Bandage interlock 615 could check electrical continuity around the edge of the bandage 50. If for example, the edge and side reflectors (see FIGS. 5a, 5b, and 12e) were made of conductive materials, and edge continuity circuit could be provided. Visible wavelength light could also be provided as output light from the bandage, to at least be an indicator that the device is operational. Presumably, when one or more of the interlock and safety sensors went off, indicating a potential leak of laser light from the bandage, aside from through aperture 515, the laser sources would be disabled and fault warning would be activated. However, the solutions of FIG. 15 are cumbersome, and burden the bandage with various electrical connections. As an alternative, FIGS. 12a and 12b illustrate a concept of providing on or more monitor optical fibers 335. These optical fibers would not supply input light to substrate 50, but would rather collect some feedback light, which could then be monitored via detectors (not shown) and software resident in controller 20. Optical continuity across the bandage would then be provided, with significantly fewer electrical connections, particularly on the bandage 50. Other design choices can be made relative to laser safety. For example, the outer surfaces of the imbedded optical fibers 330 (the jacketing) could be roughened, not to effect light coupling (as with FIG. 13a), but to increase pull resistance, when the fibers 330 are imbedded in the substrate material. The increased pull resistance or friction could come from improved mechanical or chemical bonding.

More generally the mechanical strength of the bandage could be enhanced by imbedding reinforcement threads, similar to those used in fiberglass reinforced tape, within bandage 100. These threads could be imbedded in substrate 50, or in, or proximal to, the upper layers such as top reflector 70 or cover 88. As another example, if bandage 100 has top reflective material 70 or a cover 88 made from a thin flexible mylar (polyester) sheet, as mylar is a very tough material, it would provide protection against accidental damage. In either case, the mechanical integrity of bandage 100 could then be significantly enhanced with minimal impact on the conformability.

As described, light therapy device 40 likely employs at least one high power (˜1.0+ W) high power class IV fiber pigtailed lasers, or a larger multitude of lower power class III lasers. It could be inconvenient for a clinician to handle this multiplicity of optical fibers and interconnects. Thus, as suggested with respect to FIGS. 10a-10c, a robust easily aligned coupling assembly, for example, using internal V-groove structures, can greatly lessen this burden. As an alternate approach, an input light guide, fiber optical cable 12 or fiber bundle could transport the input light to the bandage 100, as generally depicted in FIG. 4. In this case, fewer, higher power lasers might be used. However, the fiber optic cable 12 could then fan out into an imbedded set of optical fibers (as in FIG. 12a-12c) or into an imbedded circle to line converter. In the latter case, a surface of the circle to line converter could be patterned, by embossing, etching, diffusion, or other means with light extraction features 500. The proximal end of fiber optic cable 12 could be fusion coupled to the circle to line converter.

It was previously mentioned that wounds could be complex and require complex approaches to treatment. For example, FIG. 8b depicts a wound with full thickness skin loss, with the wound 205 penetrating the epidermis 220 and the dermis 230, as well as a portion of the subcutaneous tissue 240. As shown in FIG. 8b, light therapy bandage 100 is provided as a secondary dressing, with a primary wound dressing 250 packed into the wound 205. In this illustration, therapeutic light (λ) is shown propagating through the primary dressing to be incident on the deeper tissues. As some primary wound dressings used for wound packing, such as hydrofiber (Convatec Aquacel) and alginate dressings, can become reasonably transparent when wet, this is plausible. However, some packing dressings, such as the KCI wound care vacuum sponge, are not presently optically transparent. In such cases, it may be desirable to route the therapeutic light into the wound. As shown in FIG. 8c, light therapy bandage 100 could have bandage extensions 375 that could be inserted into the wound 205. Correspondingly, FIG. 12f depicts a bandage 100 with optical fibers with side surface light extraction routed into bandage extensions 375.

It should be understood that the light therapy device of the present invention has been described in a general way, and that various modifications and additions are anticipated that could be made. For example, bandage 100 could include an internal light diffuser, polarizing filter, spectral filter, or other optical element imbedded in the substrate 50 to alter the light before it reaches the tissue. Additionally device 100 could have antibiotic properties, including the possible use of a transparent anti-biotic silver, as is described in copending, commonly-assigned, French Patent Application 0508508, filed Aug. 11, 2005 by Y. Lerat et al. Bandage 100 could also have added bio-sensing capabilities or topical agents that encourage epithelialization or other tissue healing activities, to possibly amplify the effects of light therapy. In the case of bio-sensing, the bio-sensor features might detect a bio-physical or bio-chemical condition of the treatment area, which can then be used as input to guide further treatments. For example, the biosensors might detect the presence or absence of certain pathogens or enzymes associated with infections, or other enzymes and proteins associated with healing. Light therapy bandage 100 could also be equipped with a sensing means that changes color relative to time to indicate the time (or amount of exposure) and thereby indicates an end to a given therapy session; For example, biosensors could be used to look for bio-chemical indications of the effective dosage applied. Alternately, optical sensors could detect the backscattered light as measure of the optical dosage delivered. The end of session control could then be manual or automatic.

The light therapy device 100 of the present invention has been principally considered with respect to the anticipated use in treating human patients for light therapy and PDT. Certainly, the bandage 100 could be used for other purposes, of which veterinary care is the most obvious. A potential use for industrial or agricultural purposes is unclear, and yet the bandage 100 could be used to deliver light to an irregular area in which there is relevant concern for moisture in the area, and/or thermal loading in the area of application or the device itself.

The invention has been described in detail with particular reference to a presently preferred embodiment, but it will be understood that variations and modifications can be effected within the scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

10 fiber optic pad
12 fiber optic cable
14 drive unit
16 connector
20 controller
22 display
24 front panel
30 light extraction features
32 light transition area
35 liner
37 shell
40 light therapy device
50 light guide substrate (or optical substrate)
52 input surface
54 side surface
56 end surface
58 outer surface
60 inner surface (tissue side surface, exit surface)
62 therapeutic light
70 reflective material (or layer or coating)
72 total internal reflection layer (or cladding)
75 light extraction layer
77 light extraction area
80 optical coupling layer
81 other optical layers
82 mirror layer
84 tissue interface layer
86 adhesive layer
88 cover
100 light therapy bandage (or dressing or pad)
200 tissue
205 wound
207 tunneling or undermining
210 skin surface
220 epidermis
225 stratum corneum
230 dermis
240 subcutaneous tissue
250 primary dressing
300 light source
305 input light
310 optical fiber
315 fiberend
316 core
317 cladding
320 optical fiber array
330 input optical fibers
335 monitor optical fibers
340 fiber connectors
350 intermediate assembly
355 input interface
360 grooves
365 dovetails (slots)
370 input coupling optic
375 extensions
400 barrier layer (porous membrane)
405 vapor channels
410 seal
415 weld
420 optical gel (or foam)
430 upper layer
435 lower layer.
500 light extraction features
505 scatter beads
510 spacer beads
515 aperture or window
550 cross woven fibers
555 embossing drum
560 opposing drum
600 interlocks and cabling
605 power monitor
610 bandage interlock
615 signage

1. A light therapy device for delivering light energy to treat medical conditions in tissues comprising:
a) a light source, comprising one or more light emitters, which provide input light;
b) a light coupling means comprising one or more optical fibers for coupling said input light into a bandage portion comprising a flexible optical substrate;
c) a light extraction means for directing a portion of said input light out of said bandage and towards one or more localized areas of said tissues;
d) a semi-permeable transparent membrane, attached directly or indirectly to said substrate, which controls a flow of moisture and moisture vapor to and from said tissues; and
e) a controller means, which controls a light dosage emitted from said light therapy device.

2. A device as in claim 1 wherein vapor channels traverse through at least said substrate, wherein said vapor channels transfer moisture vapor from said semi-permeable transparent membrane to an outside environment.

3. A device as in claim 1 wherein said semi-permeable transparent membrane provides barrier properties relative to the flow of bacteria and water into said tissues.

4. A device as in claim 1 wherein said semi-permeable membrane is a polyurethane based thin film.

5. A device as in claim 1 wherein said bandage is utilized as a primary or a secondary dressing for wound care.

6. A device as in claim 1 wherein said light source is a laser source.

7. A device as in claim 1 wherein laser safety features such as interlocks, bandage continuity detection, and light coupling continuity detection, are provided.

8. A device as in claim 1 wherein said light source emits red light, infrared light in a spectral range of 700-1300 nm.

9. A device as in claim 1 wherein an outer surface of said substrate closest to a surrounding environment, has a layer of polyester or Mylar film applied to it.

10. A device as in claim 1 wherein said substrate or adjacent attached layers further comprises an arrangement of reinforcement threads to improve a mechanical integrity of said bandage.

11. A device as in claim 1 wherein said light coupling means partially comprises a detachable intermediate assembly.

12. A device as in claim 1 comprising one or more enhancements selected from a group consisting of optical filters, anti-biotic, or bio-sensing means.

13. A light therapy device for delivering light energy to treat medical conditions in tissues comprising:
a) a light source, comprising one or more light emitters, which provides input light;
b) a light coupling means comprising one or more optical fibers for coupling said input light into a bandage portion comprising a flexible optical substrate;
c) a light extraction means for directing a portion of said input light out of said bandage and towards one or more localized areas of said tissues;
d) a controller means, which controls a light dosage emitted from said light therapy device; and
wherein said substrate includes an optically transparent gel, liquid, or foam.

14. A device as in claim 13 wherein said light extraction means are patterned onto an optical surface within said substrate.

15. A device as in claim 13 wherein said light extraction features are patterned onto a surface of said optical fibers.

16. A light therapy device for delivering light energy to treat medical conditions in tissues comprising:
a) a light source, comprising one or more light emitters, which provides input light;
b) a light coupling means comprising one or more optical fibers for coupling said input light into a bandage portion comprising a flexible optical substrate;
c) a light extraction means for directing a portion of said input light out of said bandage and towards one or more localized areas of said tissues;
d) a controller means; which controls a light dosage emitted from said light therapy device;.
wherein said optical fibers are imbedded into said optical substrate; and
wherein said optical fibers are patterned with surface structures along a length of an outer surface, so as to provide said light extraction means.

17. A device as in claim 16 wherein said outer surfaces of said optical fibers are roughened to improved bonding of said optical fibers with said substrate.

18. A device as in claim 16 wherein said surface structures are created by embossing, etching, abrading, or processes which removes or alters optical fiber cladding material, thereby causing light to leak from side surfaces of said optical fibers.

19. A device as in claim 16 wherein said optical fibers are imbedded in said substrate with said patterned surface structures on each of said optical fibers nominally oriented in a same direction, such that said light extraction from said optical fibers is provided in a common nominal direction.

20. A device as in claim 16 wherein said optical fibers are imbedded in said optical substrate in a multi-directional serpentine distribution.

21. A device as in claim 16 wherein said optical fibers are distributed laterally within said substrate in a semi-randomized serpentine distribution.

22. A device as in claim 16 wherein said light source is a laser source.

23. A device as in claim 16 wherein said substrate at least partially comprises a material that is liquid, gel, or foam.

24. A device as in claim 16 wherein said bandage includes at least some features selected from a group consisting of edge seal, welds, or spacers to contain and control said gel, liquid, or foam substrate material.

25. A device as in claim 16 wherein said bandage includes bandage extensions and said optical fibers are imbedded within said bandage extensions with at least a portion of said light extraction means positioned within said bandage extensions.

26. A light therapy device for delivering light energy to treat medical conditions in tissues comprising
a) a light source, comprising one or more light emitters, which provides input light;
b) a light coupling means comprising one or more optical fibers for coupling said input light into a bandage portion comprising a flexible optical substrate;
c) a light extraction means for directing a portion of said input light out of said bandage and towards one or more localized areas of said tissues;
d) a semi-permeable transparent membrane, attached directly or indirectly to said substrate, which controls a flow of moisture and moisture vapor to and from said tissues;
e) a controller means, which controls a light dosage emitted from said light therapy device;
wherein said optical fibers are imbedded into said optical substrate;
wherein said optical fibers are patterned with surface structures along a length of an outer surface, so as to provide said light extraction means; and
wherein said substrate comprises an optically transparent gel, liquid, or foam material.

27. A device as in claim 26 wherein vapor channels traverse through at least said substrate, and transfer moisture vapor from said semi-permeable transparent membrane to an outside environment.

28. A device as in claim 26 wherein said patterned surface structures are created by a process, such as embossing, etching, or abrading, that removes or alters optical fiber cladding material, thereby causing light to leak from said outer surfaces of said optical fibers.

29. A device as in claim 26 wherein said optical fibers are imbedded in said substrate with said patterned surface structures on each of side of said optical fibers, nominally oriented in a same direction, such that said light extraction from said optical fibers is in a common nominal direction.

30. A device as in claim 26 wherein said outer surfaces of said optical fibers are roughened to improved the bonding of said optical fibers with said substrate.

31. A device as in claim 26 wherein said optical fibers are imbedded in said optical substrate in a multi-directional'serpentine distribution.

32. A device as in claim 26 wherein said bandage includes features selected from a group consisting of an edge seal, welds, and spacers to contain and control said gel, liquid, or foam substrate material.

33. A device as in claim 32 wherein vapor channels are routed through said welds.

34. A light therapy bandage for delivering light energy to treat medical conditions in tissues comprising:
a) a light source, comprising one or more light emitters, which provides input light;
b) a light coupling-means comprising one or more optical fibers for coupling said input light into a flexible optical substrate;
c) a light extraction means for directing a portion of said input light out of said bandage and towards one or more localized areas of said tissues;
d) a semi-permeable transparent membrane, attached directly or indirectly to said substrate, which controls a flow of moisture and moisture vapor to and from said tissues;
e) vapor channels, which traverse through at least said substrate;
wherein said optical fibers are imbedded into said optical substrate;
wherein said optical fibers are patterned with surface structures along a length of an outer surface, so as to provide said light extraction means; and
wherein said vapor channels can transfer moisture vapor from said semi-permeable transparent membrane to an outside environment.

35. A bandage as in claim 34 wherein said semi-permeable transparent membrane provides a barrier to present relative flow of bacteria and water into said tissues.

36. A bandage as in claim 34 wherein said outer surfaces of said optical fibers are roughened to improved bonding of said optical fiber with said substrate.

37. A bandage as in claim 34 wherein said patterned surface structures are created by embossing, etching, or abrading, that removes or alters optical fiber cladding material, thereby causing light to leak from side surfaces of said optical fibers.

38. A bandage as in claim 34 wherein said optical fibers are imbedded in said substrate with said patterned surface structures on each of side optical fibers nominally oriented in a same direction, such that said light extraction from said optical fibers is in a common nominal direction.

39. A bandage as in claim 34 wherein said optical fibers are imbedded in said optical substrate in a multi-directional serpentine distribution.

40. A bandage as in claim 34 wherein said bandage includes bandage extensions and said optical fibers are imbedded within said bandage extensions with at least a portion of said light extraction means positioned within said bandage extensions.

41. A light therapy bandage for delivering light energy to treat medical conditions in tissues comprising:
a) a light source, comprising one or more light emitters, which provides input light;
b) a light coupling means comprising one or more optical fibers for coupling said input light into a flexible optical substrate;
c) a light extraction means for directing a portion of said input light out of said bandage and towards one or more localized areas of said tissues;
d) a semi-permeable transparent membrane, attached directly or indirectly to said substrate, which controls a flow of moisture and moisture vapor to and from said tissues;
e) vapor channels, which traverse through at least said substrate; and
wherein said vapor channels transfer moisture vapor from said semi-permeable transparent membrane to an outside environment.

42. A bandage as in claim 41 wherein said light extraction means include scatter beads imbedded in said substrate.

43. A bandage as in claim 41 wherein said light extraction means include optical micro-structures, formed in, or attached to, said substrate.

44. A bandage as in claim 43 wherein said optical micro-structures are provided on an outer side of said substrate, rather than proximal to said tissues.

45. A bandage as in claim 41 wherein said substrate at least partially comprises a material selected from a group consisting of liquid, gel, or foam.

46. A bandage as in claim 45 wherein said material has a higher refractive index than surrounding layers proximal to said material.

47. A bandage as in claim 41 wherein said bandage is provided with a reflector to re-direct light misdirected by said light extraction means back into said substrate.

48. A bandage as in claim 47 wherein said reflector is offset from said substrate by spacers.

49. A bandage as in claim 41 wherein said input light directed out of said bandage towards said localized areas of said tissues passes through one or more apertures which provided a transparent window film, or as areas without reflective or light blocking layers.

50. A bandage as in claim 41 wherein said light source is a laser source.

51. A bandage as in claim 41 wherein said light source emits red light, infrared light in a spectral range of 700-1300 nm.

52. A light therapy bandage for delivering light energy to a portion of a patient's body to treat medical conditions in tissues comprising:
a) a light source, comprising one or more light emitters, which provides input light via one or more optical light guides;
b) an intermediate detachable bandage member which connects with said optical light guides and which also connects with a flexible optical substrate;
c) a light coupling means within said intermediate detachable bandage member which comprises one or more optical fibers which couple said input light into said substrate; and
d) a light extraction means for directing a portion of said input light out of said bandage and towards one or more localized areas of said tissues.

53. A bandage as in claim 52 wherein said intermediate detachable bandage member connects to said substrate with positive locking features such as dovetails.

54. A bandage as in claim 52 wherein said intermediate detachable bandage member includes a groove structure to enhance conformability.

55. A bandage as in claim 52 wherein said intermediate detachable bandage member has a physical profile relative to said substrate which minimizes protrusions that could become pressure points relative to said patient's body.

56. A bandage as in claim 52 wherein coupling means comprises a lens, a diffuser, an index matching gel or liquid, or a combination thereof.

57. A light therapy device for delivering light energy to treat medical conditions in tissues comprising:
a) a light source, comprising one or more laser sources, which provides laser light as input light;
b) a light coupling means comprising one or more optical fibers for coupling said input light into a bandage portion comprising a flexible optical substrate;
c) a light extraction means for directing a portion of said input light out of said bandage and towards one or more localized areas of said tissues;
d) a controller means, which controls a light dosage emitted from said light therapy device; and
e) a safety system, operated by said controller, which can detect a leakage of said laser light.

58. A device as in claim 57 wherein said safety system includes monitor optical fibers that are provided to collect light from said substrate.

59. A device as in claim 57 wherein said safety system includes an optical sensor to monitor a portion of said light energy which is being directed towards said tissues.

60. A device as in claim 57 wherein said safety system includes a bandage edge continuity sensing means.

61. A light therapy bandage for delivering light energy to treat medical conditions in tissues comprising:
a) a light source, comprising one or more light emitters, which provides input light via a plurality of optical fibers;
b) a flexible optical substrate which includes a portion comprising a series of linear extensions; wherein said optical fibers are imbedded within said extensions; and
c) light extraction surface structures patterned along a length of said optical fibers, which extracts input light from said optical fibers, wherein said length is at least within said extensions.

62. A light therapy bandage for delivering light energy to treat medical conditions in tissues comprising:
a light source, comprising one or more light emitters, which provides input light via a plurality of optical fibers;
b) a flexible optical substrate in which said optical fiber are imbedded;
c) a light extraction means for directing a portion of said input light out of said bandage from within a light extraction area and towards a localized area of said tissues; and
wherein said optical fibers are spiral into a nominal center of said bandage from edges of said bandage; and
wherein crosswoven fibers are interlaced with said optical fibers with and said light extraction area to provide microbending of said optical fibers and thus light extraction.

63. A bandage as in claim 62 wherein a semi-permeable transparent membrane, attached directly or indirectly to said substrate, controls a flow of moisture and moisture vapor to and from said tissues.

64. A bandage as in claim 63 wherein vapor channels, traverse through at least said substrate and transfer said moisture vapor from said semi-permeable transparent membrane to an outside environment.

65. A light therapy device for delivering light energy to treat medical conditions in tissues comprising:
a) a light source, comprising one or more laser sources, which provides laser light as input light;
b) a light coupling means comprising one or more optical fibers for coupling said input light into a bandage portion comprising a flexible optical substrate;
c) a light extraction means for directing said input light out of said device and towards said tissues;
d) a semi-permeable transparent membrane, attached directly or indirectly to said substrate, which controls a flow of moisture and moisture vapor to and from said tissues;
e) a controller, which controls a light dosage emitted from said light therapy device; and
f) a safety system, operated by said controller, which detects a leakage of said laser light.

66. A device as in claim 65 wherein vapor channels traverse through at least said substrate, transfer moisture vapor from said semi-permeable transparent membrane to an outside environment.
